(19) United States
(12) Patent Application Publication
(10) Pub. No.: US 2008/0101473 A1
(43) Pub. Date: May 1, 2008

(54) TRANSCODING APPARATUS AND TRANSCODING METHOD

(75) Inventors: Takeshi TANAKA, Osaka (JP); Tokuzo KIYOHARA, Osaka (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/923,779

(22) Filed: Oct. 25, 2007

(30) Foreign Application Priority Data
Oct. 26, 2006 (JP) 2006-290934

(51) Int. Cl. H04N 7/26

(52) U.S. Cl. 375/240.16; 375/240.24; 375/E07.124

(57) ABSTRACT

A transcoding apparatus and a transcoding method convert MPEG-2 compressed video to H.264 compressed video without increasing the circuit size while also preventing loss of image quality. The transcoding apparatus has a transcoder. The transcoder has an MPEG-2 decoder for decoding an MPEG-2 video stream, a data transform unit, and a H.264 encoder. The data transform unit converts the header information, macroblock information, and motion vector information of the macroblocks in the decoded MPEG-2 video stream to the header information, macroblock information, and motion vector information of H.264 macroblocks. The H.264 encoder encodes the MPEG-2 video stream as an H.264 video stream based on the converted information.

### BACKGROUND OF THE INVENTION

1. Field of the Invention

The present invention relates to a transcoding apparatus and a transcoding method for converting image data compressed according to the MPEG-2 standard to image data compressed according to the H.264 standard.

2. Related Art

The H.264 standard is increasingly used for image compression. The H.264 standard enables more precise motion compensation because it enables dividing an image into smaller macroblocks than the widely used MPEG-2 standard. The H.264 standard also has an intra-prediction mode for using spatial correlations. The H.264 standard also uses many new compression tools such as arithmetic coding. For these and other reasons, the H.264 standard improves video compression performance by a factor of more than two when compared with the MPEG-2 standard. This has created demand for transcoding apparatuses for recompressing streams that are compressed using the MPEG-2 standard used for broadcasting, for example, with H.264 standard streams in order to more effectively use the capacity of the video stream storage devices.

Technologies for converting from one image compression standard to another image compression standard have previously been proposed. Japanese Unexamined Patent Appl. Pub. JP-A-2005-12527, for example, teaches a technology for converting from the MPEG-4 standard that enables further partitioning macroblocks into smaller sub-blocks to the MPEG-1 standard that does not enable partitioning macroblocks into smaller sub-blocks. FIG. 33A to FIG. 33D show an example of the transform method taught in JP-A-2005-12527. The method taught in JP-A-2005-12527 selects the one motion vector determined to be most effective from among the motion vectors for each of the four MPEG-4 sub-blocks, and uses the selected motion vector as the motion vector for the MPEG-1 macroblock. For example, the motion vector for the top left sub-block 33a is selected in FIG. 33A, the motion vector for the top right sub-block 33b is selected in FIG. 33B, the motion vector for the bottom left sub-block 33c is selected in FIG. 33C, and the motion vector for the bottom right sub-block 33d is selected in FIG. 33D. MPEG-4 sub-blocks are thus converted to MPEG-1 macroblocks by selecting and using one motion vector from among the motion vectors for each of the sub-blocks.

Japanese Patent No. 2933561 teaches technology for converting from the MPEG-2 standard to the H.263 standard. When converting from the MPEG-2 standard to the H.263 standard, the transcoding apparatus taught in JP2933561 changes the size of the image while also scaling the MPEG-2 motion vector.

The method taught in JP-A-2005-12527 uses the motion vector of the standard before transformation as the motion vector after transformation, but the motion vector that can be used is the motion vector for only one of the sub-blocks. The sub-block from which the motion vector is selected uses the same motion vector after transformation, but the sub-blocks from which the motion vector was not selected use different motion vectors before and after transformation. Image quality deterioration is therefore severe.

The transformation method taught in JP2933561 can be used to convert from one standard to another when the macroblock segment size is the same in both standards. However, when the macroblock segment size is not the same in the standard before transformation and the standard after transformation, the motion vector cannot be used as the motion vector after transformation by simply scaling the motion vector.

Due to differences in the segment size, there are cases with the related art in which the motion vector of the standard before transformation cannot be used as the motion vector after transformation. Because of differences in the macroblock structure and the reference modes of the MPEG-2 standard and the H.264 standard, the macroblock segment size can also differ. Using the technology of the related art to convert from the MPEG-2 standard to the H.264 standard therefore results in degraded image quality in the converted stream. In order to reduce image quality deterioration, a motion detection process must be applied to a various macroblock structures and reference modes over a wide image area. This increases the amount of computation required and therefore increases the circuit size and cost.

### SUMMARY OF THE INVENTION

A transcoding apparatus and a transcoding method convert an MPEG-2 standard compressed video stream to an H.264 standard compressed video stream without increasing the circuit scale while preventing image quality deterioration.

A first aspect of the invention is a transcoding apparatus for converting the encoding standard of encoded image data. The transcoding apparatus has a decoding unit for decoding data encoded according to a first encoding standard, a transformation unit that receives picture structure information and macroblock referencing information input from the decoding unit, and converts the picture structure information and the macroblock referencing information to picture structure information and macroblock referencing information according to a second encoding standard, and an encoding unit that encodes the data decoded by the decoding unit according to the second encoding standard using the picture structure information and macroblock referencing information which were converted by the transformation unit.

This picture structure information corresponds to the header information described in the following embodiments of the invention. The macroblock referencing information corresponds to the macroblock information and the motion vector information in the following embodiments of the invention.

The transformation unit preferably sets the picture structure of the second encoding standard to a field structure when the picture structure of the first encoding standard is a field structure, and sets the picture structure of the second encoding standard to a frame structure and an MBAFF (Macro Block Adaptive Frame Field) structure when the picture structure of the first encoding standard is a frame structure.

Further preferably, the transformation unit converts the macroblocks of the first encoding standard to a field macroblock pair of two 16×8-reference-based macroblocks of the second encoding standard when two vertically consecutive macroblocks in the frame structure of the first encoding standard are frame-reference-based and field-reference-based.

Yet further preferably, the transformation unit converts the frame-reference-based macroblock to field-reference-based macroblock, and then converts two macroblocks of the first encoding standard to the field macroblock pair of two 16×8 macroblocks of the second encoding standard.

Further preferably, the transformation unit converts the intra macroblock to an inter macroblock, and then converts the two vertically consecutive macroblocks in the frame structure of the first encoding standard to a field macroblock pair of two 16×8-reference-based macroblocks of the second encoding standard when two vertically consecutive macroblocks in the frame structure of the first encoding standard are an intra macroblock and a field-reference-based macroblock.

Yet further preferably, the transformation unit converts the intra macroblock to an inter macroblock with a motion vector equal to pMV (predicted Motion Vector).

Yet further preferably, the transcoding apparatus also has a storage unit for storing data decoded by the decoding unit. In this aspect of the invention the encoding unit applies motion compensation according to macroblock referencing information converted by the transformation unit to data stored by the storage unit without applying motion detection.

In another aspect of the invention the transcoding apparatus also has a storage unit for storing data decoded by the decoding unit, and the encoding unit applies motion detection according to macroblock referencing information converted by the transformation unit to data stored by the storage unit.

A transcoding apparatus according to another aspect of the invention has a decoding unit for decoding data encoded according to a first encoding standard, applying an inverse frequency transform to the decoded data, and outputting difference data; a memory for storing the difference data; a transformation unit that receives picture structure information and macroblock referencing information input from the decoding unit, and converts the picture structure information and the macroblock referencing information to picture structure information and macroblock referencing information according to a second encoding standard; and an encoding unit that encodes the difference data in memory according to the second encoding standard using the picture structure information and macroblock referencing information which were converted by the transformation unit.

Preferably, the transformation unit sets the picture structure of the second encoding standard to a field structure when the picture structure of the first encoding standard is a field structure, and sets the picture structure of the second encoding standard to a frame structure and is an MBAFF structure when the picture structure of the first encoding standard is a frame structure.

Further preferably, the transformation unit converts the macroblocks of the first encoding standard to a field macroblock pair of two 16×8-reference-based macroblocks of the second encoding standard when two vertically consecutive macroblocks in the frame structure of the first encoding standard are frame-reference-based and field-reference-based.

Yet further preferably, when two vertically consecutive macroblocks in the frame structure of the first encoding standard are an intra macroblock and a field-reference-based macroblock, the transformation unit converts the intra macroblock to an inter macroblock, and then converts the two vertically consecutive macroblocks in the frame structure of the first encoding standard to a field macroblock pair of two 16×8-reference-based macroblocks of the second encoding standard.

The transformation unit can convert the intra macroblock to an inter macroblock that weights the reference picture zero.

The transformation unit can also convert the intra macroblock to an inter macroblock with a motion vector equal to pMV.

Another aspect of the invention is a transcoding method for converting the encoding standard of encoded image data. The transcoding method has decoding data encoded according to a first encoding standard; converting picture structure information and macroblock referencing information acquired from the decoding step to picture structure information and macroblock referencing information according to a second encoding standard; encoding the data decoded by the decoding step according to the second encoding standard using the picture structure information and macroblock referencing information which were converted by the converting step.

A transcoding method according to another aspect of the invention has decoding data encoded according to a first encoding standard; storing difference data after an inverse frequency transform is applied by the decoding step; converting the picture structure information and the macroblock referencing information acquired from the decoding step to picture structure information and macroblock referencing method information according to a second encoding standard; and encoding the difference data stored in the storage step according to the second encoding standard using the picture structure information and macroblock referencing information which were converted by the converting step.

The invention provides a transcoding apparatus and a transcoding method that can convert MPEG-2 compressed video to H.264 compressed video without increasing the circuit size while also preventing loss of image quality.

More specifically, the transcoding apparatus and transcoding method of the invention convert the macroblock partition method and reference mode of an MPEG-2 encoded stream to the partition method and reference mode of H.264 macroblocks according to the macroblock partition method and reference mode of the MPEG-2 encoded stream. The motion vector information of the MPEG-2 stream can therefore be used without conversion. Loss of image quality can therefore also be prevented. Because a computationally expensive motion detection process is not required, the circuit size can also be reduced and a low cost can be achieved.

The transcoding apparatus and transcoding method according to another aspect of the invention store the difference data after applying an inverse frequency transform to data encoded according to a first encoding standard, and encodes the stored difference data according to a second encoding standard according to the H.264 macroblock partitioning method and reference mode converted by the conversion means. Transcoding is therefore possible with a simple motion vector conversion without using a reference picture. Loss of image quality can therefore also be prevented. The circuit size can also be reduced and a low cost can be achieved.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 is a block diagram of a transcoding apparatus according to a first embodiment of the invention.

FIG. 2 is a block diagram of the transcoder according to a first embodiment of the invention.

FIG. 3 is a block diagram of the MPEG-2 decoder according to a first embodiment of the invention.

FIG. 4 is a block diagram of the information transform unit according to a first embodiment of the invention.

FIG. 5 is a block diagram of the H.264 encoder according to a first embodiment of the invention.

FIG. 6A describes the concept of MPEG-2 macroblock partitioning.

FIG. 6B describes the concept of H.264 macroblock partitioning.

FIG. 7A is a list of MPEG-2 reference mode.

FIG. 7B is a list of H.264 reference mode.

FIG. 7C is a list of reference mode of H.264 MBAFF structure.

FIG. 8 is a table showing the types of reference modes in MPEG-2 field structures in the first embodiment of the invention.

FIGS. 9A, 9B, and 9C show partitioning patterns and reference modes of MPEG-2 field structure macroblocks in the first embodiment of the invention.

FIG. 10 describes referencing between MPEG-2 field structure pictures in the first embodiment of the invention.

FIGS. 11A, 11B, 11C, 11D, and 11E show partitioning patterns and reference modes of H.264 field structure macroblocks in the first embodiment of the invention.

FIG. 12 describes referencing between H.264 field structure pictures in the first embodiment of the invention.

FIG. 13 shows the types of MPEG-2 frame structure reference modes in the first embodiment of the invention.

FIGS. 14A, 14B, and 14C show partitioning patterns and reference modes of MPEG-2 frame structure macroblocks in the first embodiment of the invention.

FIG. 15 describes referencing between MPEG-2 frame structure pictures in the first embodiment of the invention.

FIG. 16A shows MBAFF-structure frame macroblock pairs in the H.264 frame structure in the first embodiment of the invention.

FIG. 16B shows MBAFF-structure field macroblock pairs in the H.264 frame structure in the first embodiment of the invention.

FIG. 17 describes referencing between H.264 frame structure pictures in the first embodiment of the invention.

FIG. 18 is a flow chart describing the header information conversion method in the first embodiment of the invention.

FIGS. 19A, 19B, 19C, and 19D show conversion from MPEG-2 field structures to H.264 field structures in the first embodiment of the invention, specifically, FIG. 19A is a table of macroblock partitioning patterns, FIG. 19B shows a 16×16 macroblocks, FIG. 19C shows 16×8 macroblocks, and FIG. 19D shows intra macroblocks.

FIG. 20 is a flow chart describing converting reference information from a MPEG-2 field structure to H.264 field structure in the first embodiment of the invention.

FIG. 21 is a table describing conversion of the macroblock partition patterns and reference modes from MPEG-2 frame structures to H.264 MBAFF structures of frame structures in the first embodiment of the invention.

FIGS. 22A, 22B, and 22C show conversion of macroblock partition patterns from MPEG-2 frame structures to H.264 MBAFF structures when the upper and lower macroblocks of the MPEG-2 frame structure have the same reference mode in the first embodiment of the invention.

FIGS. 23A, 23B, and 23C show conversion of macroblock partition patterns from MPEG-2 frame structures to H.264 MBAFF structures when the upper and lower macroblocks of the MPEG-2 frame structure have different reference modes in the first embodiment of the invention.

FIG. 24 is a flow chart describing conversion of reference information from the MPEG-2 frame structure to H.264 MBAFF structures in the first embodiment of the invention.

FIG. 25 is a block diagram of an H.264 encoder according to a second embodiment of the invention.

FIG. 26 is a block diagram of a transcoder according to a third embodiment of the invention.

FIG. 27 is a block diagram of an MPEG-2 decoder according to a third embodiment of the invention.

FIG. 28 is a block diagram of an H.264 encoder according to a third embodiment of the invention.

FIG. 29 is a flow chart describing the header information conversion process according to the third embodiment of the invention.

FIG. 30 describes references between pictures with an H.264 frame structure in the third embodiment of the invention.

FIG. 31A describes conversion to H.264 macroblocks when an intra macroblock and a field-reference-based macroblock are vertically consecutive in a MPEG-2 frame structure in the third embodiment of the invention.

FIG. 31B describes converting an intra macroblock to a field-reference-based macroblock.

FIG. 32 is a block diagram of a transcoding apparatus according to a fourth embodiment of the invention.

FIGS. 33A, 33B, 33C, and 33D describe conversion from MPEG-4 to MPEG-1 according to the related art.

### DETAILED DESCRIPTION OF THE PREFERRED EMBODIMENTS

Preferred embodiments of the present invention are described below with reference to the accompanying figures.

### Embodiment 1

1. Configuration

1.1 General Configuration of Transcoding Apparatus

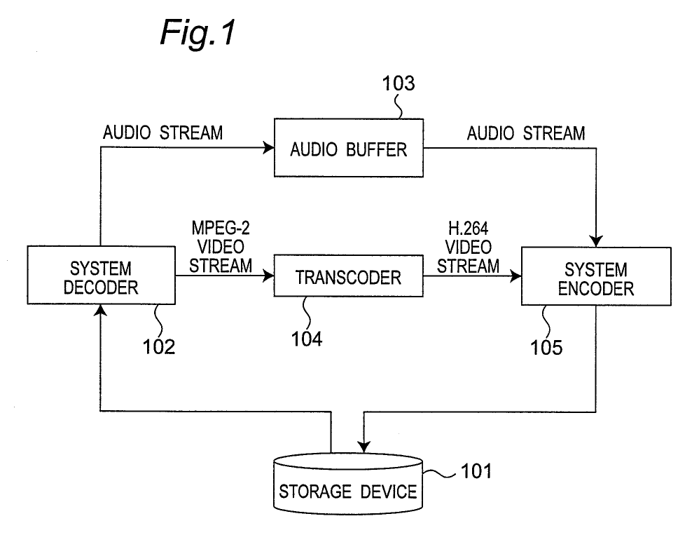

FIG. 1 shows the configuration of a transcoding apparatus according to a first embodiment of the invention. The transcoding apparatus according to this embodiment of the invention has a storage device 101 for storing the compressed streams before and after transformation, a system decoder 102 for separating the compressed stream into an audio stream and a video stream, a transcoder 104 for standard transformation, an audio buffer 103 for storing the audio stream for a specific time, and a system encoder 105 for multiplexing the audio stream and video stream.

The storage device 101 stores a stream compressed according to the MPEG-2 standard, and an H.264 stream that is converted from the MPEG-2 stream.

The system decoder 102 reads the MPEG-2 compressed stream from the storage device 101, and separates the audio stream and the video stream from the read stream. The audio stream is output to the audio buffer 103, and the video stream is output to the transcoder 104.

The transcoder 104 converts the MPEG-2 video stream acquired from the system decoder 102 to an H.264 video stream, and outputs the H.264 standard video stream to the system encoder 105.

The audio buffer 103 delays output of the audio stream to the system encoder 105 for a prescribed delay interval in order to synchronize the audio and video.

The system encoder 105 multiplexes the audio stream output from the audio buffer 103 and the H.264 video stream output from the transcoder 104 while synchronizing the streams, and writes the multiplexed stream to the storage device 101.

1.2 Internal Configuration of the Transcoder

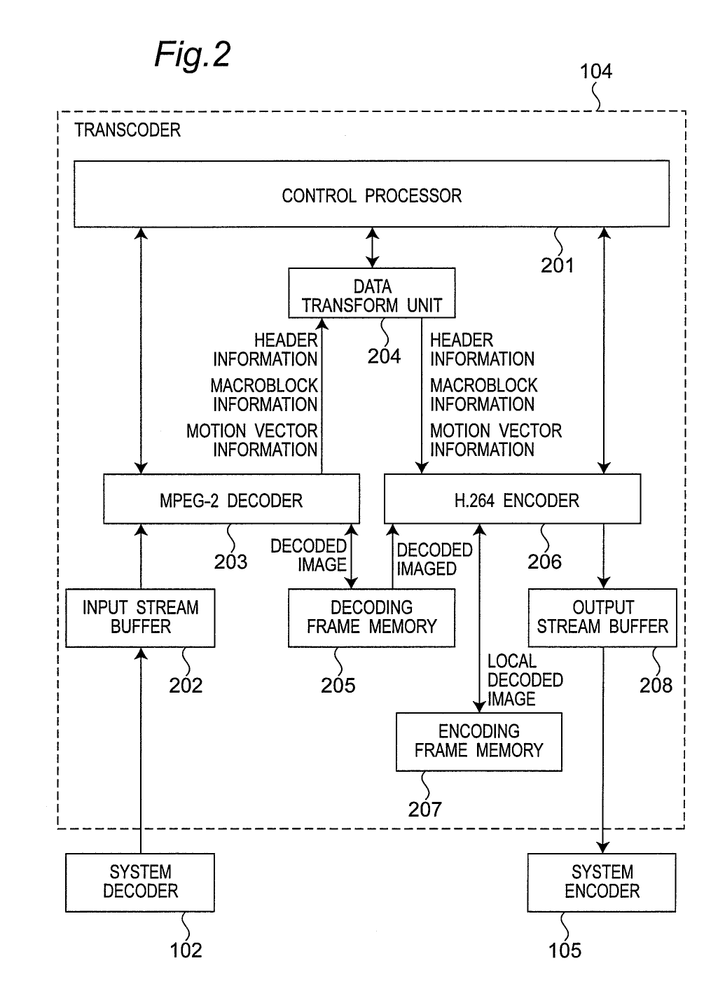

The internal configuration of the transcoder 104 is shown in FIG. 2. The transcoder 104 includes an input stream buffer 202, a MPEG-2 decoder 203, and a decoding frame memory 205 that are required for decoding the MPEG-2 video stream, and a H.264 encoder 206, an encoding frame memory 207, and an output stream buffer 208 that are required for encoding an H.264 video stream. The transcoder 104 also has a data transform unit 204 that converts the information related to the macroblocks of an MPEG-2 stream to information related to the macroblocks of an H.264 stream, and a control processor 201 for controlling the internal operations of the transcoder 104.

The input stream buffer 202 temporarily stores the MPEG-2 compressed stream input from the system decoder 102.

The MPEG-2 decoder 203 reads and decodes the MPEG-2 stream from the input stream buffer 202, and outputs the decoded image data to the decoding frame memory 205.

The decoding frame memory 205 stores the decoded image data that is decoded by the MPEG-2 decoder 203. The MPEG-2 decoder 203 also outputs the information related to the macroblocks contained in the decoded image data, or more specifically the header information, macroblock information, and motion vector information, to the data transform unit 204. The macroblocks and the header information, macroblock information, and motion vector information are described in further detail below.

The data transform unit 204 converts the MPEG-2 header information, macroblock information, and motion vector information to H.264 standard header information, macroblock information, and motion vector information, and inputs the converted information to the H.264 encoder 206.

The H.264 encoder 206 encodes the decoded image read from the decoding frame memory 205 to the H.264 standard based on the H.264 standard header information, macroblock information, and motion vector information acquired from the data transform unit 204. During encoding the H.264 encoder 206 outputs the decoded image read from the decoding frame memory 205 as a local decoded image to the encoding frame memory 207. When encoding a P picture or B picture, both of which reference a previous picture, the H.264 encoder 206 reads the local decoded image stored in the encoding frame memory 207 as the referenced picture. The encoding frame memory 207 thus stores a local decoded image, and the H.264 encoder 206 reads this stored image as the reference picture when needed. The H.264 encoder 206 outputs the encoded H.264 stream to the output stream buffer 208.

The output stream buffer 208 outputs the H.264 stream input from the H.264 encoder 206 to the system encoder 105.

The control processor 201 controls and synchronizes the operation of the MPEG-2 decoder 203, the H.264 encoder 206, and the data transform unit 204.

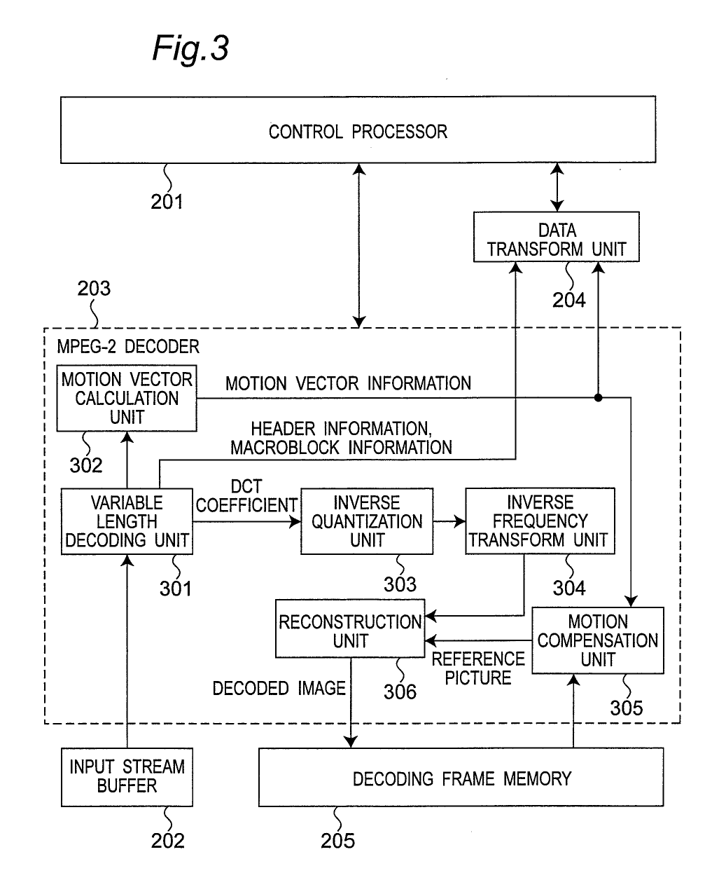

In this embodiment of the invention the data transform unit 204 converts the header information, macroblock information, and motion vector information related to the stream before conversion to the header information, macroblock information, and motion vector information of the stream after conversion, and based on this converted information, the decoded MPEG-2 stream is encoded as an H.264 stream. More specifically, no motion detection processing is done, and the motion vector information of the stream being converted is used as the motion vector information of the stream after conversion. There is therefore no loss of image quality after stream conversion. The internal configurations of the MPEG-2 decoder 203, the data transform unit 204, and the H.264 encoder 206 are described below with reference to FIG. 3 to FIG. 5.

1.3 Internal Configuration of the MPEG-2 Decoder

FIG. 3 shows the internal configuration of the MPEG-2 decoder 203 shown in FIG. 2.

The MPEG-2 decoder 203 includes a variable length decoding unit 301 for variable length decoding a stream received from the input stream buffer 202, a motion vector calculation unit 302 for calculating the motion vector information, and a motion compensation unit 305, an inverse quantization unit 303, an inverse frequency transform unit 304 and a reconstruction unit 306 for decoding the MPEG-2 stream based on the output from the variable length decoding unit 301 and the motion vector calculation unit 302.

The variable length decoding unit 301 variable length decodes the MPEG-2 stream received from the input stream buffer 202, and gets the header information, macroblock information, and DCT coefficient from the decoded stream. If the decoded stream is an intra macroblock, motion vector information is also acquired from the decoded stream. The header information and the macroblock information are output to the data transform unit 204. The DCT coefficient is output to the inverse quantization unit 303. The motion vector information is output to the motion vector calculation unit 302.

The motion vector calculation unit 302 converts the motion vector value contained in the motion vector information to the actual motion vector value using the prediction value. The motion vector calculation unit 302 also outputs the motion vector information containing the converted motion vector value to the data transform unit 204 and the motion compensation unit 305.

The motion compensation unit 305 reads the reference picture pointed to by the motion vector information calculated by the motion vector calculation unit 302 from the decoding frame memory 205. The motion compensation unit 305 applies a half-pel calculation to the read reference picture. If the decoded image is a B picture, an averaging process is applied to the two reference pictures. The motion compensation unit 305 outputs the processed reference picture to the reconstruction unit 306 after the calculations are completed.

The inverse quantization unit 303 inverse quantizes the acquired DCT coefficient and outputs the result to the inverse frequency transform unit 304.

The inverse frequency transform unit 304 inverse frequency transforms the acquired DCT coefficient and outputs the result to the reconstruction unit 306.

If the macroblock is an intra macroblock, the reconstruction unit 306 outputs the acquired data directly to the decoding frame memory 205 as the decoded image. If the macroblock is an inter macroblock, the reconstruction unit 306 generates and outputs the decoded image to the decoding frame memory 205 by adding the DCT coefficient from the inverse frequency transform unit 304 to the reference image acquired from the motion compensation unit 305.

1.4 Internal Configuration of the Data Transform Unit

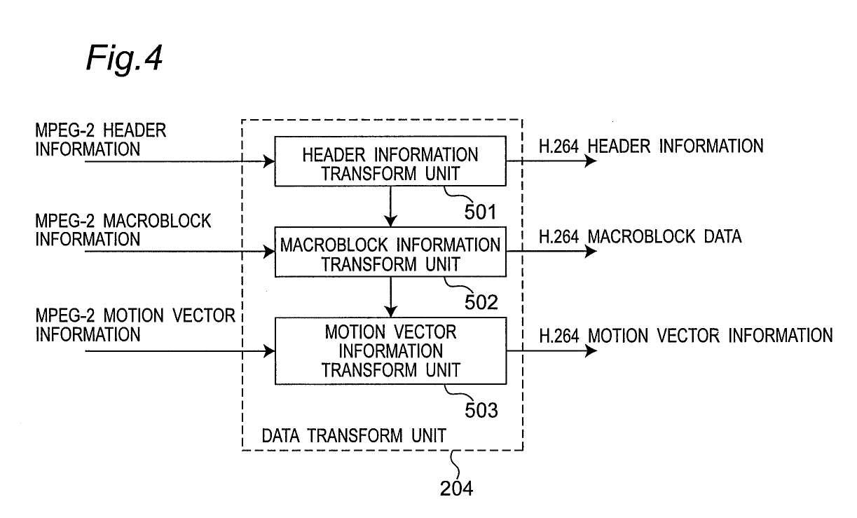

FIG. 4 shows the internal configuration of the data transform unit 204 in FIG. 2.

The data transform unit 204 includes a header information transform unit 501 for converting the MPEG-2 header information to H.264 header information, a macroblock information transform unit 502 for converting the MPEG-2 macroblock information to H.264 macroblock information, and a motion vector information transform unit 503 for converting the MPEG-2 motion vectors to H.264 motion vectors. The data transform operation of the data transform unit 204 is described in further detail below.

1.5 Internal Configuration of the H.264 Encoder

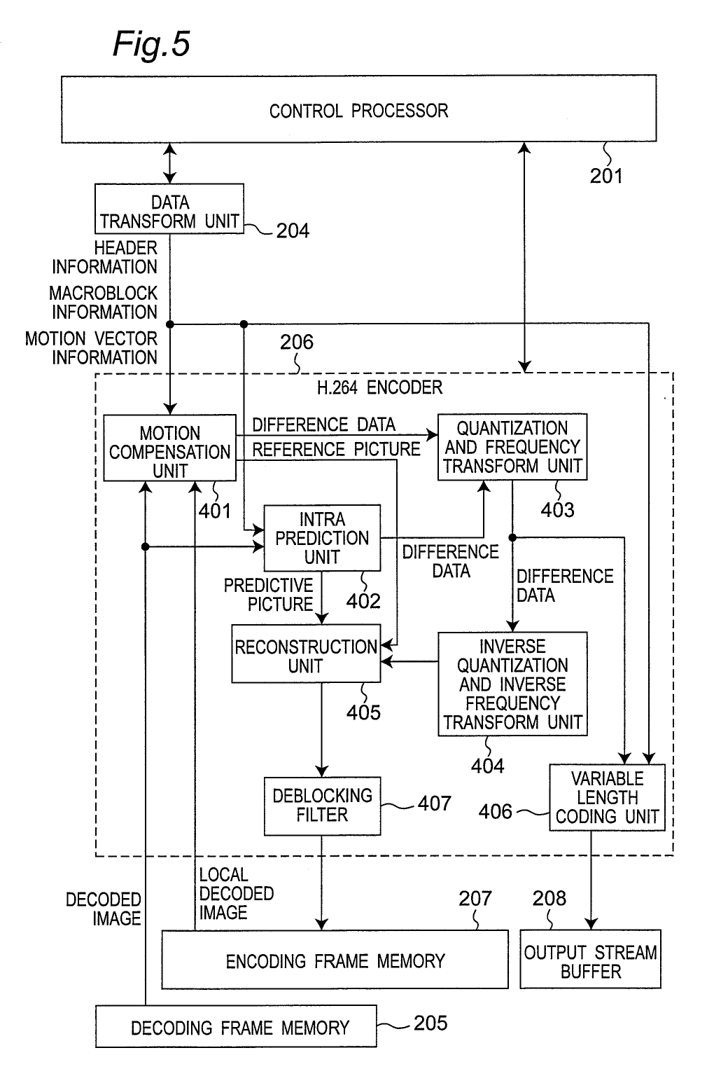

FIG. 5 shows the internal configuration of the H.264 encoder 206 in FIG. 2.

The H.264 encoder 206 includes a motion compensation unit 401 that operates when the macroblock being encoded is an inter macroblock, an intra prediction unit 402 that operates when the macroblock being encoded is an intra macroblock, a quantization and frequency transform unit 403 that quantizes and frequency transforms the data output from the motion compensation unit 401 or the intra prediction unit 402, and a reconstruction unit 405 that generates a local decoded image for an inter macroblock.

The H.264 header information, the H.264 macroblock information, and the H.264 motion vector information output from the data transform unit 204 are input to the motion compensation unit 401, the intra prediction unit 402, and the variable length coding unit 406. The H.264 header information and the H.264 macroblock information denote which reference mode is used for encoding. Because the motion vector information is acquired from the output of the data transform unit 204, the H.264 encoder 206 in this embodiment of the invention does not have a motion detection unit for detecting the motion vector information.

When encoding to an inter macroblock is specified, the motion compensation unit 401 gets the local decoded image at the position indicated by the motion vector information from the encoding frame memory 207 based on the H.264 motion vector information input from the data transform unit 204. The motion compensation unit 401 applies the filter operation specified by the H.264 standard to the acquired local decoded image and computes the position of the reference picture with the decimal point precision. The motion compensation unit 401 outputs the difference data between the calculated reference image and the local decoded image read from the encoding frame memory 207 to the quantization and frequency transform unit 403, and outputs the calculated reference image to the reconstruction unit 405.

When encoding to an intra macroblock is specified, the intra prediction unit 402 gets the decoded image from the decoding frame memory 205 and applies intra prediction as defined by the H.264 standard. More specifically, the intra prediction unit 402 determines the predicted direction of the read decoded image and generates a predicted image. The intra prediction unit 402 outputs the predicted image to the reconstruction unit 405, and outputs the difference data between the predicted image and the decoded image to the quantization and frequency transform unit 403.

The quantization and frequency transform unit 403 quantizes and frequency transforms the difference data output from the motion compensation unit 401 or the intra prediction unit 402.

The H.264 encoder 206 also has an inverse quantization and inverse frequency transform unit 404 and a variable length coding unit 406 to which the difference data output from the quantization and frequency transform unit 403 is input.

The inverse quantization and inverse frequency transform unit 404 inverse quantizes and inverse frequency transforms the quantized and frequency transformed difference data output from the quantization and frequency transform unit 403, and outputs to the reconstruction unit 405.

Based on the H.264 standard header information, macroblock information, and motion vector information, the variable length coding unit 406 encodes the frequency transformed difference data and outputs to the output stream buffer 208. The difference data output to the output stream buffer 208 becomes the H.264 video stream.

The reference image from the motion compensation unit 401 is input to the reconstruction unit 405 when encoding to an inter macroblock, and the predicted image resulting from intra prediction is input to the reconstruction unit 405 when encoding to an intra macroblock. The inverse quantized and inverse frequency transformed difference data from the inverse quantization and inverse frequency transform unit 404 is also input to the reconstruction unit 405. The reconstruction unit 405 adds the difference data to the reference image or predicted image, and reconstructs the original image.

The H.264 encoder 206 also has a deblocking filter 407 for applying the deblocking filtering defined by the H.264 standard. The deblocking filter 407 applies deblocking filtering to the reconstructed image output by the reconstruction unit 405, and outputs the result as the local decoded image to the encoding frame memory 207. The local decoded image input to the encoding frame memory 207 is read by the motion compensation unit 401 when encoding to an inter macroblock.

The transcoder 104 shown in FIG. 1 to FIG. 5 converts an MPEG-2 video stream to an H.264 video stream using MPEG-2 macroblock units. The macroblocks are described below.

2. Macroblock Structure

2.1 MPEG-2 Macroblocks and H.264 Macroblocks

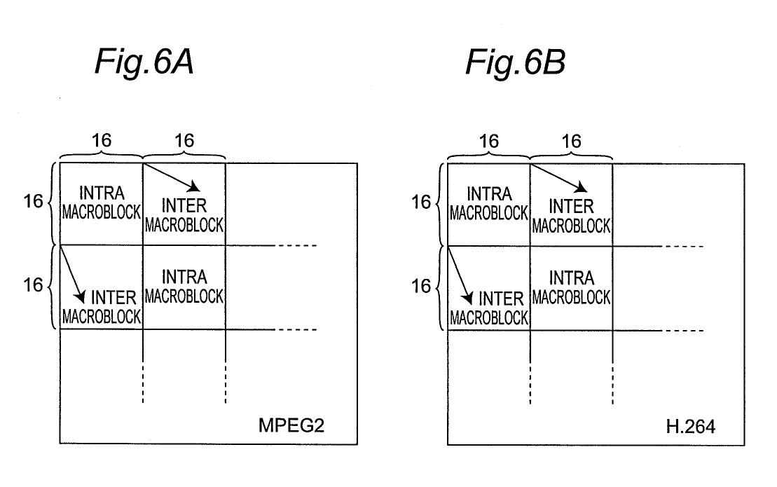

FIG. 6A and FIG. 6B schematically show MPEG-2 and H.264 macroblocks. MPEG-2 and H.264 divide the image data for one frame of the video stream into multiple macroblocks, and apply compression and motion compensation by macroblock unit. FIG. 6A and FIG. 6B show an example in which the macroblocks are 16 pixels by 16 pixels. The unit used by the transcoder 104 in this embodiment of the invention when converting from MPEG-2 macroblocks to H.264 macroblocks is one 16×16 pixel MPEG-2 macroblock or two vertically adjoining macroblocks.

MPEG-2 and H.264 macroblocks have various reference modes. The transcoder 104 according to this embodiment of the invention therefore converts MPEG-2 macroblocks to H.264 macroblocks using a conversion method appropriate to the reference mode of the MPEG-2 macroblocks. MPEG-2 macroblock reference modes and H.264 macroblock reference modes are described next.

2.2 MPEG-2 and H.264 Macroblock Reference modes

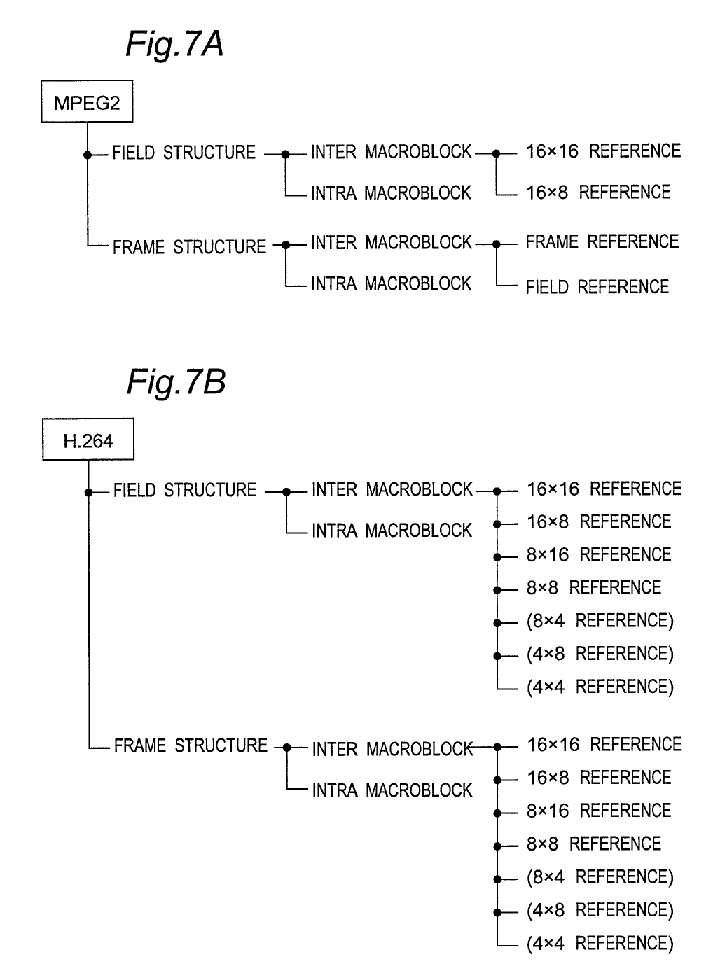

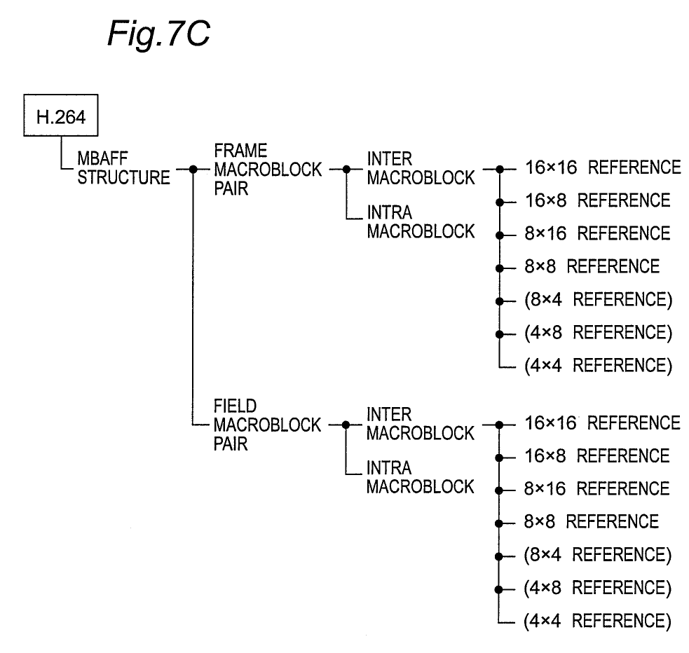

FIG. 7A to FIG. 7C lists the reference modes of MPEG-2 and H.264 macroblocks.

As shown in FIG. 7A, MPEG-2 has a field structure in which image data is encoded in field units, and a frame structure in which image data is encoded in frame units. A frame denotes one screen portion, and each frame is composed of plural fields. The field structure contains inter macroblocks that apply motion compensation by referencing other pictures, and intra macroblocks that do not reference other pictures. Inter macroblocks that reference other pictures contain motion vector information that describes the movement from the other picture. Inter macroblocks have a 16×16 reference mode that reference 16×16 pixel units, and a 16×8 reference mode that references 16×8 pixel units. The frame structure also contains inter macroblocks and intra macroblocks. Inter macroblocks are also separated into frame-reference-based macroblocks that references frame units, and field-reference-based macroblocks that reference field units.

As shown in FIG. 7B, H.264 has a field structure in which image data are encoded in field units, and a frame structure in which image data is encoded in frame units. The field structure and the frame structure contain inter macroblocks that apply motion compensation by referencing other pictures, and intra macroblocks that do not reference other pictures. Inter macroblocks that reference other pictures contain motion vector information that describes the movement from the other picture. Inter macroblocks have a 16×16 reference mode that reference 16×16 pixel units, a 16×8 reference mode that references 16×8 pixel units, an 8×16 reference mode that references 8×16 pixel units, an 8×8 reference mode that references 8×8 pixel units, and other smaller size reference modes. Other smaller size reference modes, that is, an 8×4 reference mode, a 4×8 reference mode, and a 4×4 reference mode are not used in the embodiment.

As shown in FIG. 7C, as one aspect of the frame structure, the frame structure includes a Macro Block Adaptive Frame Field (MBAFF) that handles two vertically consecutive macroblocks as a macroblock pair, and macroblock pairs are also separated into frame macroblock pairs that references frame units, and field macroblock pairs that reference field units. The frame macroblock pair and the field macroblock pair contain inter macroblocks and intra macroblocks, respectively. Inter macroblocks have a 16×16 reference mode, a 16×8 reference mode, an 8×16 reference mode, an 8×8 reference mode, and other smaller size reference modes. Other smaller size reference modes, that is, an 8×4 reference mode, a 4×8 reference mode, and a 4×4 reference mode are not used in this embodiment.

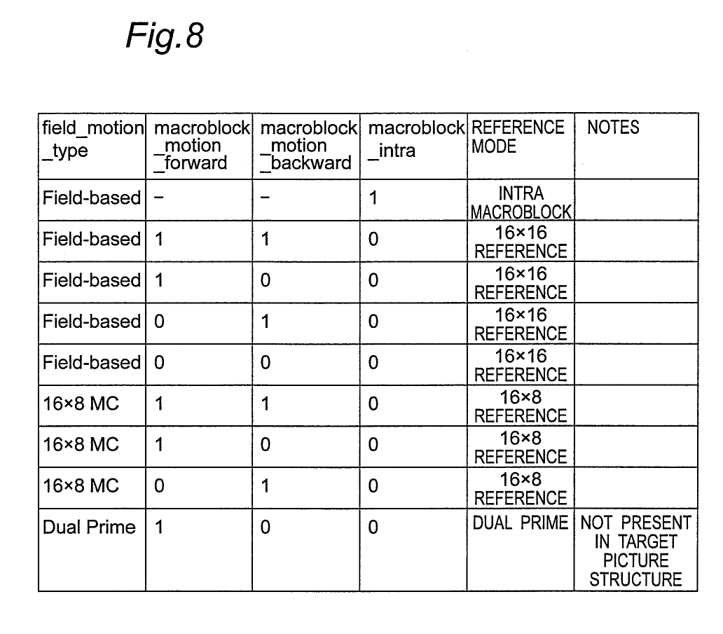

In this embodiment, macroblocks with the MPEG-2 field structure are converted into macroblocks with the H.264 field structure, and macroblocks with the MPEG-2 frame structure are converted into macroblocks with the H.264 MBAFF structure. In this embodiment, the H.264 frame structure except for MBAFF structure in FIG. 7B is not used for converting. Examples of the MPEG-2 and H.264 reference modes shown in FIGS. 7A-7C except for the H.264 frame structure in FIG. 7B are described in detail below with reference to FIG. 8 to FIG. 17.

2.3 Field Structure

2.3.1 MPEG-2

FIG. 8 is a table showing the macroblock prediction types in a MPEG-2 field and the reference mode for each macroblock type. As shown in FIG. 8, the MPEG-2 macroblock types are defined in the MPEG-2 standard according to the “field_motion_type”, “macroblock_motion_forward”, “macroblock_motion_backward”, and “macroblock_intra” settings.

The “field_motion_type” includes three types of, field-based, 16×8 MC, and DualPrime. The “macroblock_motion_forward” flag is 1 bit (1, 0) indicating whether motion prediction is forward or not. The “macroblock_motion_backward” flag is 1 bit (1, 0) indicating whether motion prediction is backward or not. The “macroblock_intra” flag is 1 bit where “1” indicates an intra macroblock and “0” indicates an inter macroblock.

The reference modes for macroblocks classified by the “field_motion_type”, “macroblock_motion_forward”, “macroblock_motion_backward”, and “macroblock_intra” flags are intra macroblock, 16×16 reference, and 16×8 reference. If the “field_motion_type” flag is set to DualPrime, the reference mode is DualPrime, but because Dual prime is not used for MPEG-2 stream with GOP structure including B-picture which is generally used in the broadcast, the DualPrime reference mode is beyond the scope of this embodiment.

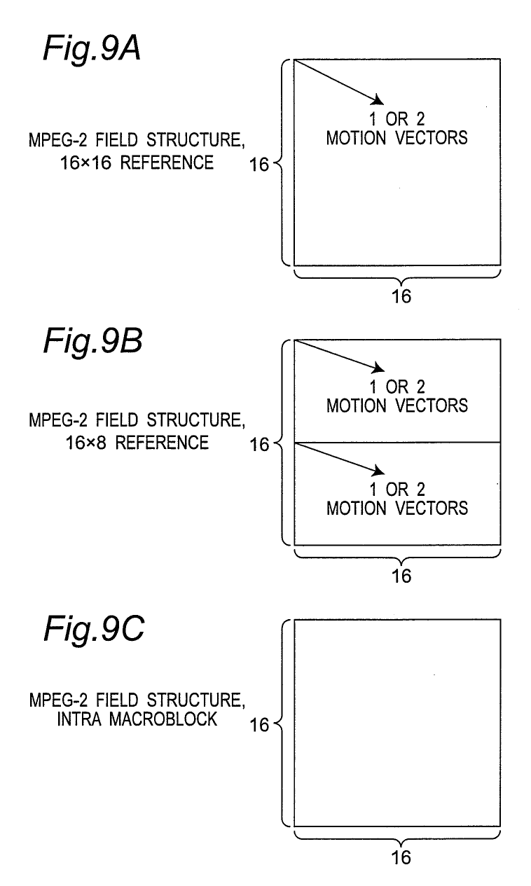

Specific examples of 16×16 reference, 16×8 reference, and intra macroblock reference modes are shown in FIG. 9A to FIG. 9C.

The 16×16 reference mode shown in FIG. 9A references one or two references pictures using one or two motion vectors. More specifically, one motion vector is used if the referencing picture is a P picture, and two motion vectors are used if the referencing picture is a B picture.

The 16×8 reference mode shown in FIG. 9B partitions one macroblock into two parts top and bottom, and references one or two reference pictures using two or four motion vectors. More specifically, two motion “vectors are used for a P picture, and four motion vectors are used for a B picture.

The intra macroblock reference mode shown in FIG. 9C does not reference a reference picture. Intra coding in the MPEG-2 standard quantizes, frequency transforms, and variable length codes the pixel values within each macroblock.

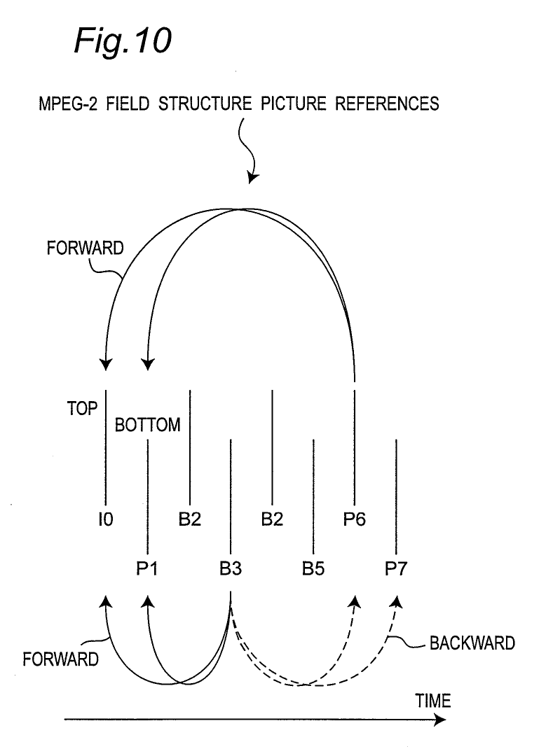

FIG. 10 describes 16×16 and 16×8 mode motion prediction.

In FIG. 10 the pictures are numbered from 0 in the order in which the pictures are presented, I pictures are denoted “I”, P pictures are denoted “P”, and B pictures are denoted “B”.

In this example picture P6, a picture in the top field, references the previous pictures I0 or P1 (forward reference). Picture B3, a picture in the bottom field, references previous pictures I0 and P1 (forward reference) and future pictures P6 and P7 (backward reference). The B pictures are shown referencing four fields in FIG. 10, but could reference two fields or six or more fields. Because P pictures skip B pictures, Dual Prime prediction is not used as defined in the standard.

2.3.2 H.264

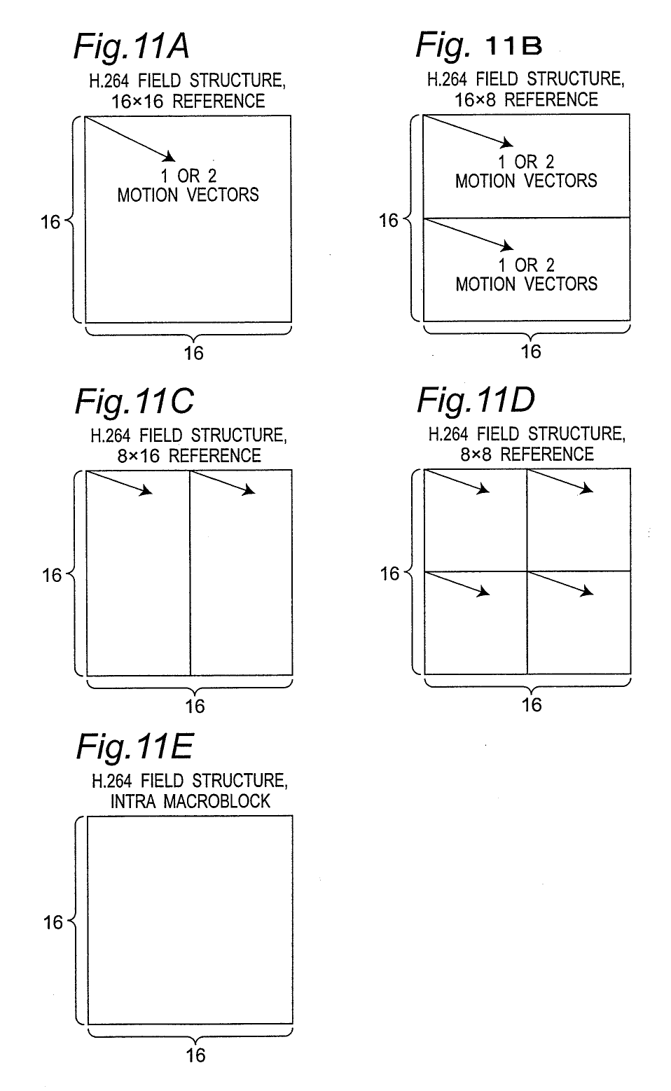

FIG. 11A to FIG. 11E describe the macroblock reference modes in a H.264 field structure. The H.264 standard allows for a variety of reference modes ranging from 16×16 to 4×4 partitions, but reference modes for partitions smaller than 8×8 are not shown in FIGS. 11A-11E.

FIG. 11A shows the 16×16 reference mode. The 16×16 reference mode references one or two references pictures using one or two motion vectors. More specifically, one motion vector is used if the referencing picture is a P picture, and two motion vectors are used if the referencing picture is a B picture.

FIG. 11B shows the 16×8 reference mode. The 16×8 reference mode partitions one macroblock into two parts top and bottom, and references one or two reference pictures using two or four motion vectors. More specifically, two motion vectors are used for a P picture, and four motion vectors are used for a B picture.

FIG. 11C shows the 8×16 reference mode. The 8×16 reference mode partitions one macroblock into two parts right and left, and references one or two reference pictures using two or four motion vectors.

FIG. 11D shows the 8×8 reference mode. The 8×8 reference mode partitions one macroblock into four parts top and bottom, and right and left, and references one or two reference pictures using four or eight motion vectors.

FIG. 11E shows the intra macroblock reference mode. The intra macroblock reference mode does not reference a reference picture. Intra coding in the H.264 standard generates a reference picture using any of nine modes from 16×16 to 4×4 based on the values of spatially neighboring pixels.

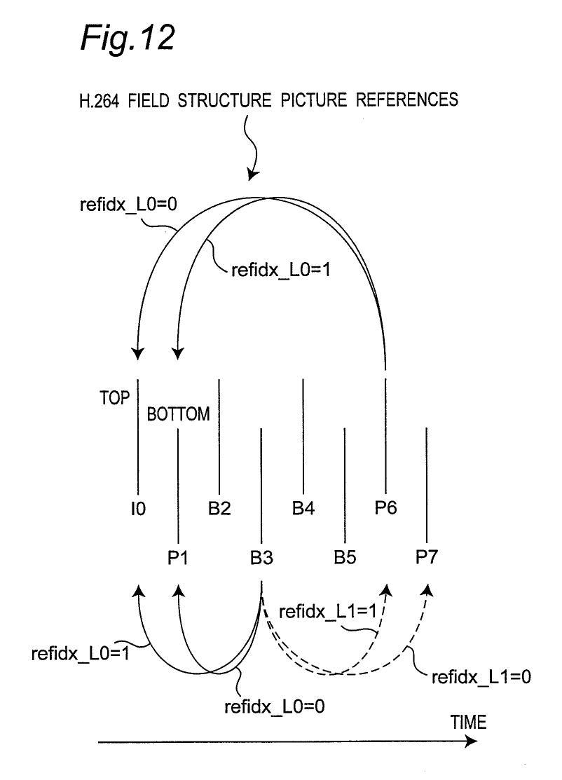

FIG. 12 describes picture referencing in the H.264 field structure. The H.264 field structure references in FIG. 12 correspond to the MPEG-2 field structure references in FIG. 10. The picture type indices (I, P, B) are the same as in FIG. 10. In FIG. 12 picture P6, a top field picture, references previous pictures I0 or P1 as “refidx_L0”=“0” or “1” (reference L0) where “refidx_” is a reference defined by the H.264 standard. The “refidx_L0” flag denotes a forward reference, and “refidx_L1” denotes a backward reference. Picture B3, a bottom field picture, references previous pictures I0 and P1 and future pictures P6 and P7 as “refidx_L0”=“0” or “1” (reference L0) and “refidx_L1”=“0” or “1” (reference L1). This embodiment of the invention converts the MPEG-2 field references shown in FIG. 10 to the H.264 field references shown in FIG. 12.

2.4 Frame structure

2.4.1 MPEG-2

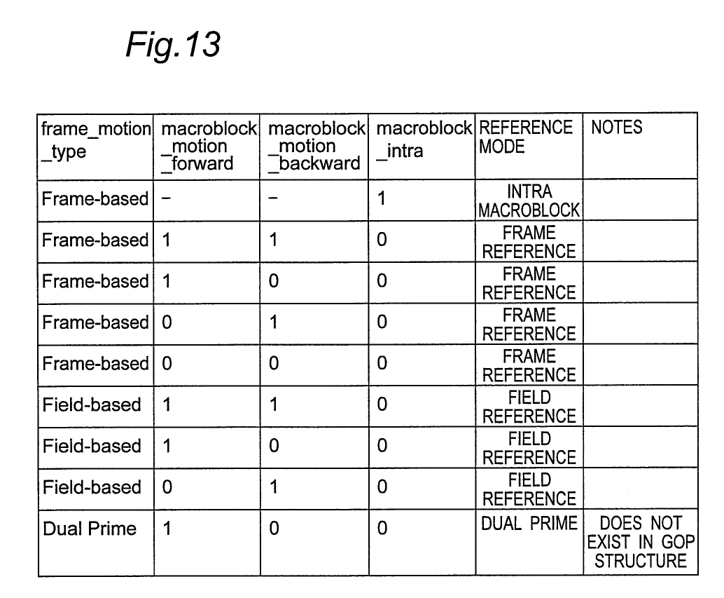

FIG. 13 shows the macroblock classification types in the MPEG-2 frame structure, and the reference modes for each type. Similarly to the field structure, the macroblock types are defined in the MPEG-2 standard according to the “frame_motion_type”, “macroblock_motion_forward”, “macroblock_motion backward”, and “macroblock_intra” settings.

The “frame_motion_type” includes Frame-based, Field-based, and DualPrime. The “macroblock_motion_forward”, “macroblock_motion_backward”, and “macroblock_intra” flags are the same as described in FIG. 8.

The reference modes for macroblocks classified by the “frame_motion_type”, “macroblock_motion_forward”, “macroblock_motion_backward”, and “macroblock_intra” flags are intra macroblock, frame reference, and field reference. If the frame_motion_type flag is set to DualPrime, the reference mode is DualPrime, but because there is no DualPrime motion prediction type in the GOP (Group of Pictures) structure to which this embodiment of the invention is directed, the DualPrime reference mode is beyond the scope of this embodiment.

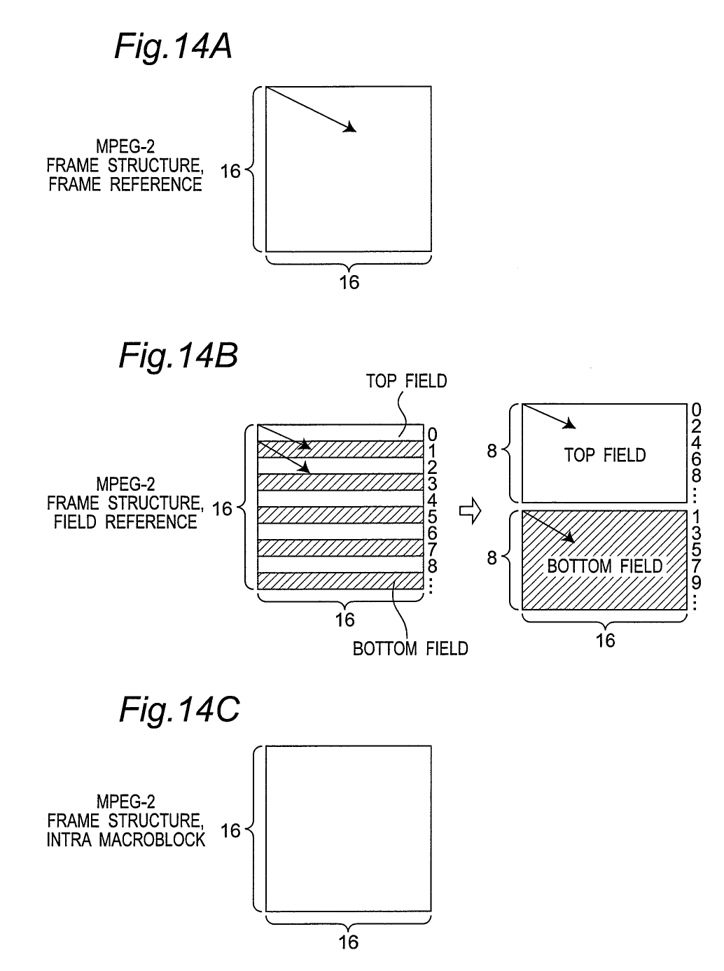

FIG. 14A to FIG. 14C describe specific examples of frame reference, field reference, and intra macroblock reference motion prediction.

Frame-based motion prediction as shown in FIG. 14A references one or two pictures using one or two motion vectors.

Field-based motion prediction as shown in FIG. 14B divides one macroblock into a top field containing even-numbered lines and a bottom field containing odd-numbered lines. Each field is 16×8 pixels. The field-based mode references one or two reference images using one or two motion vectors in both the top field and bottom field.

The intra macroblock reference mode shown in FIG. 14C does not reference a reference picture. Intra coding in the MPEG-2 standard quantizes, frequency transforms, and variable length codes the pixel values within each macroblock.

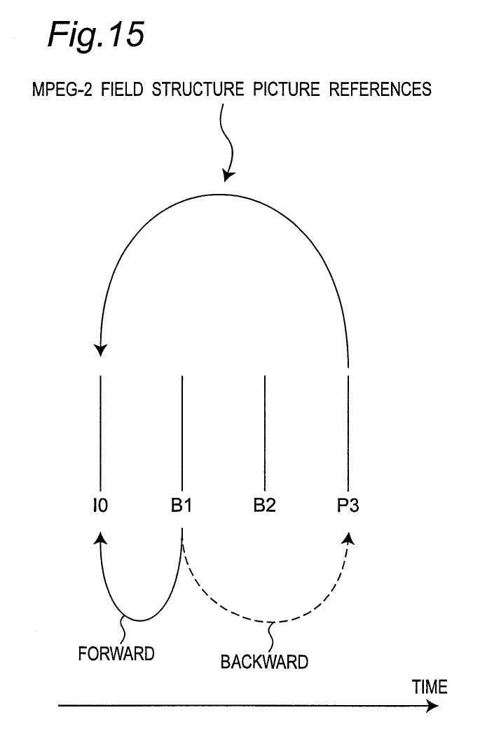

FIG. 15 describes frame-based and field-based motion prediction. In FIG. 15 the pictures are numbered from 0 in the order in which the pictures are presented, I pictures are denoted “I”, P pictures are denoted “P”, and B pictures are denoted “B”.

In this example picture P3 references the previous picture I0 (forward reference). Picture B1 references the previous picture I0 (forward reference) and the future picture P3 (backward reference). The B pictures are shown referencing two frames in FIG. 15, but could reference one frame or three or more frames. Because P pictures skip B pictures, Dual Prime prediction is not used as defined in the standard.

2.4.2 H.264

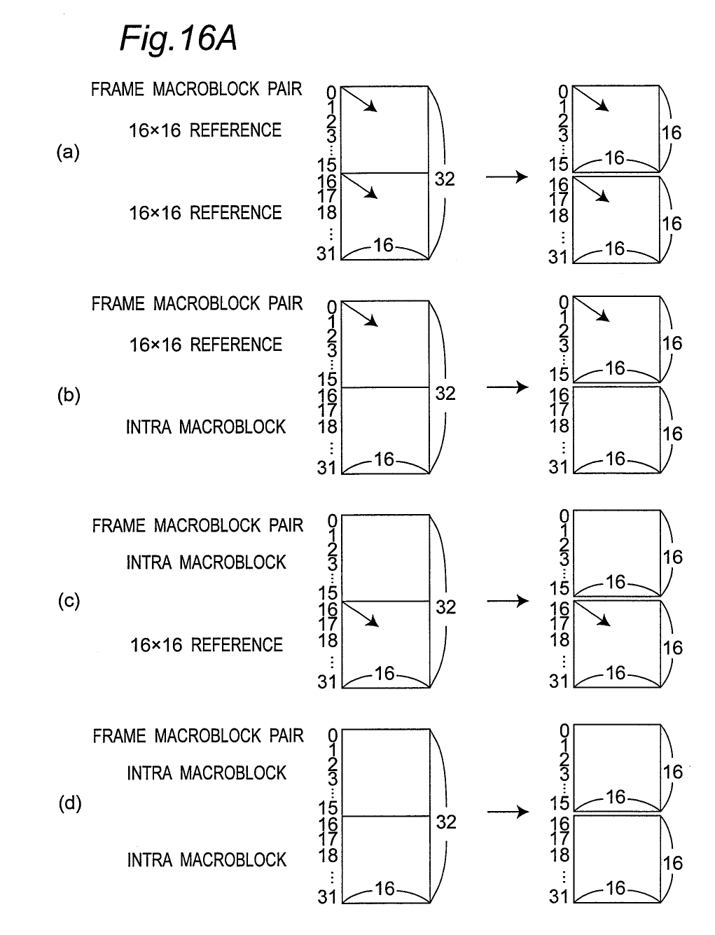

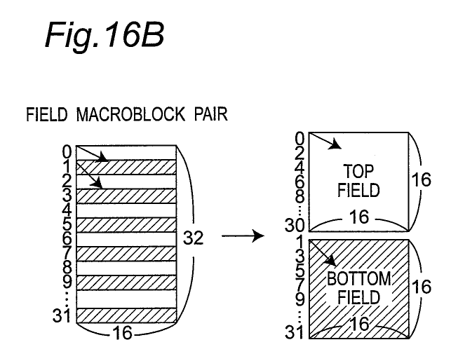

FIG. 16A and FIG. 16B show the macroblock pairs of the MBAFF (Macro Block Adaptive Frame Field) in the H.264 frame structure.

FIG. 16A shows the frame macroblock pairs. In this case a 16×32 block is spatially divided vertically into two 16×16 macroblocks, each of which is handled as a macroblock with a frame structure. In case (a) in FIG. 16A both the upper macroblock and the lower macroblock reference a 16×16 partition, in case (b) the upper macroblock references a 16×16 partition and the lower macroblock is an intra macroblock, in case (c) the upper macroblock is an intra macroblock and the lower macroblock references a 16×16 partition, and in case (d) both the upper and lower macroblocks are intra macroblocks.

FIG. 16B shows field macroblock pairs. In this case a 16×32 block is divided into two 16×16 macroblocks including a top field containing even lines and a bottom field containing odd lines, each of which is handled as a macroblock with a field structure.

The reference modes of the macroblocks contained in the frame macroblock pairs and field macroblock pairs can use intra macroblocks or reference blocks ranging from 16×16 to 4×4 in the same way as the field structure shown in FIG. 11. As described below, this embodiment of the invention uses 16×16 motion prediction, 16×8 motion prediction, or intra macroblock coding to convert from MPEG-2 to H.264.

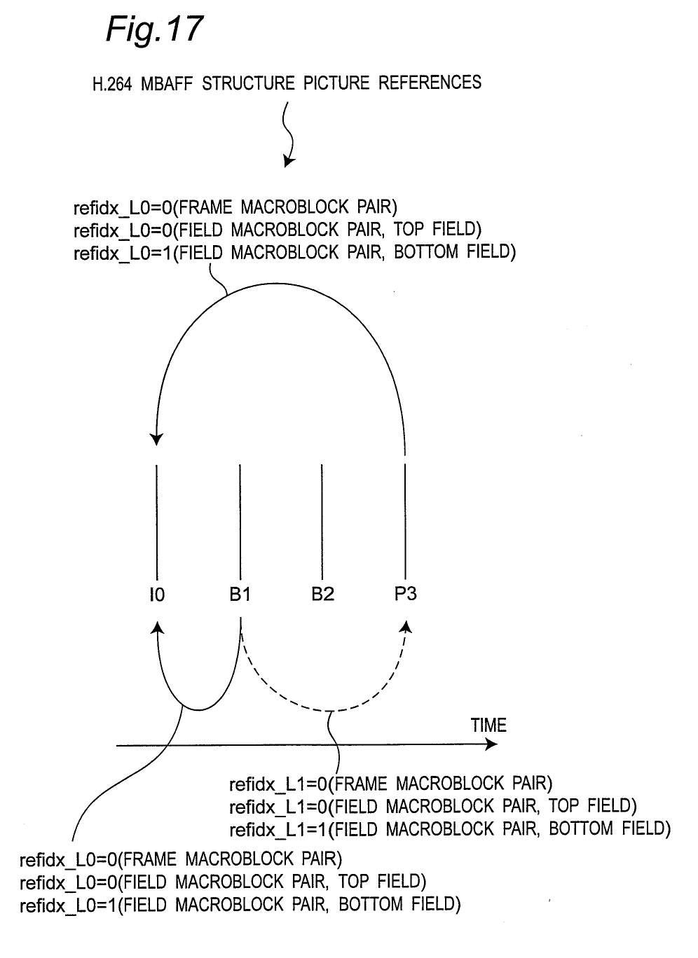

FIG. 17 describes H.264 frame structure referencing. FIG. 17 corresponds to MPEG-2 frame structure referencing as shown in FIG. 15. The picture notations are the same as in FIG. 15. Picture P3 references the previous picture I0 as refidx_L0=0 or 1 (L0 reference). Picture B1 references past picture I0 and future picture P3 as “refidx_L0”=“0” or “1” (L0 reference) and “refidx_L1”=“0” or “1” (L1 reference). More specifically, if the referenced picture is a frame macroblock pair, “refidx_L0”=“0” and “refidx_L1”=“0” are used. If the referenced picture is the top field of a field macroblock pair, “refidx_L0”=“0” and “refidx_L1”=“0” are used. If a bottom field is referenced, “refidx_L0”=“1” and “refidx_L1”=“1” are used. The MPEG-2 frame structure reference relationship shown in FIG. 15 is converted to the H.264 frame structure reference relationship shown in FIG. 17.

As shown in FIG. 6 to FIG. 17, MPEG-2 and H.264 have inter macroblocks that refer to a reference picture, and intra macroblocks that do not refer to a reference picture. The MPEG-2 decoder 203 shown in FIG. 3 and the H.264 encoder 206 shown in FIG. 5 therefore operate differently depending on whether an intra macroblock or a inter macroblock is being processed.

3. Operation of Decoder and Encoder

3.1 Operation of the MPEG-2 Decoder

The operation of the MPEG-2 decoder 203 shown in FIG. 3 is described separately for intra macroblocks and inter macroblocks.

If the MPEG-2 stream input to the variable length decoding unit 301 is an intra macroblock, the variable length decoded header information and macroblock information is output to the data transform unit 204, and the DCT coefficient is output to the inverse quantization unit 303. The inverse quantization unit 303 inverse quantizes the received DCT coefficient and outputs to the inverse frequency transform unit 304. The inverse frequency transform unit 304 inverse frequency transforms the coefficient and outputs to the reconstruction unit 306. The reconstruction unit 306 outputs the acquired data directly to the decoding frame memory 205 as the decoded image.

If the stream input to the variable length decoding unit 301 is an inter macroblock of a P picture or a B picture, the header information and the macroblock information in the variable length decoded data is output to the data transform unit 204. The motion vector value contained in the motion vector information in the variable length decoded data is converted to the actual motion vector value using the prediction value by the motion vector calculation unit 302. The motion vector information is then output to the data transform unit 204 and the motion compensation unit 305. The variable length decoded DCT coefficient is inverse quantized by the inverse quantization unit 303 and inverse frequency transformed by the inverse frequency transform unit 304. The motion compensation unit 305 reads the reference picture pointed to by the motion vector information calculated by the motion vector calculation unit 302 from the decoding frame memory 205, applies a half pel calculation or averaging operation for two reference pictures in a B picture, and then outputs the reference picture to the reconstruction unit 306. The reconstruction unit 306 outputs the decoded image acquired by adding the reference picture acquired from the motion compensation unit 305 to the data acquired from the inverse frequency transform unit 304 to the decoding frame memory 205.

3.2 Operation of the H.264 Encoder

The operation of the H.264 encoder 206 shown in FIG. 5 is described separately for intra macroblocks and inter macroblocks.

If the data transform unit 204 indicates encoding to an intra macroblock using H.264 header information and H.264 macroblock information, the intra prediction unit 402 gets the decoded image from the decoding frame memory 205 and applies intra prediction as defined in the H.264 standard. The intra prediction unit 402 then determines the prediction direction and outputs the predicted image to the reconstruction unit 405, and outputs the difference data for the predicted image and decoded image to the quantization and frequency transform unit 403. The quantization and frequency transform unit 403 applies quantization and frequency transform operations, and outputs the frequency transformed difference data to the variable length coding unit 406. The variable length coding unit 406 encodes the frequency transformed difference data and outputs to the output stream buffer 208.

The quantized and frequency transformed data from the quantization and frequency transform unit 403 is inverse quantized and inverse frequency transformed by the inverse quantization and inverse frequency transform unit 404, and output to the reconstruction unit 405. The reconstruction unit 405 reconstructs the original image by adding the predicted image obtained by intra prediction and the inverse quantized and inverse frequency transformed difference image, and outputs to the deblocking filter 407. The deblocking filter 407 applies the H.264 deblocking filtering process to the reconstructed original picture. The deblocked picture is output as the local decoded image to the encoding frame memory 207.

If the data transform unit 204 indicates encoding to an inter macroblock using H.264 header information and H.264 macroblock information, such as by referencing a 16×16 reference-based inter macroblock, the motion compensation unit 401 gets the image data at the position pointed to by the motion vector information from the encoding frame memory 207 using the 16×16 motion prediction reference and H.264 motion vector information from the data transform unit 204, applies the H.264 filtering process, and calculates the reference picture at the position with decimal accuracy.

The motion compensation unit 401 outputs the difference data for the calculated reference picture and decoded image to the quantization and frequency transform unit 403, and outputs the reference picture to the reconstruction unit 405. The quantization and frequency transform unit 403 applies quantization and frequency transformation processes, and outputs the frequency transformed difference signal to the variable length coding unit 406. The variable length coding unit 406 encodes the frequency transformed difference signal and outputs to the output stream buffer 208.

The quantized and frequency transformed data from the quantization and frequency transform unit 403 is then inverse quantized and inverse frequency transformed by the inverse quantization and inverse frequency transform unit 404, and output to the reconstruction unit 405. The reconstruction unit 405 adds the motion compensated reference picture and the inverse quantized and inverse frequency transformed difference image to reconstruct the original image, and outputs to the deblocking filter 407. The deblocking filter 407 applies H.264 deblocking. The deblocked picture is then output as the local decoded image to the encoding frame memory 207.

The same process described above is used when the data transform unit 204 directs the H.264 encoder 206 to encode using a different motion prediction reference size than 16×16, such as 16×8.

Conversion from the MPEG-2 standard to the H.264 standard is thus done by the H.264 encoder 206 encoding MPEG-2 pictures that are decoded by the MPEG-2 decoder 203 according to the H.264 standard. The encoding is done by converting the picture header information, macroblock information, and motion vector information from the MPEG-2 standard to the H.264 standard. How the data transform unit 204 converts the header information, macroblock information, and motion vector information from MPEG-2 to H.264 is described in detail next.

4. Operation of the Data Transform Unit (MPEG-2 to H.264 Conversion)

4.1 MPEG-2 and H.264 Header Information, Macroblock Information, and Motion Vector Information

The MPEG-2 header information output from the MPEG-2 decoder 203 to the data transform unit 204 is information related to the picture structure. The information related to the picture structure indicates either a field structure or a frame structure in the MPEG-2 picture header. This information is specified in the “picture-structure” in the MPEG-2 standard. The macroblock information is information defined by the MPEG-2 standard and added to macroblock units, and indicates the macroblock partitioning method (partition size) and reference mode. The macroblock information refers particularly to the “macroblock_type”, “frame_motion_type”, and “field_motion_type” in the information defined by the MPEG-2 standard. The motion vector information includes the reference information indicating the reference picture used for motion prediction, and the motion vector value indicating the location of the reference picture.

The H.264 header information output from the data transform unit 204 to the H.264 encoder 206 points to information indicating whether the picture has a field structure or a frame structure in the H.264 picture header. The header information is specified by the “field_pic_flag” and “mb_adaptive_frame_field_flag” in the H.264 standard. The H.264 macroblock information is information defined by the H.264 standard and added to macroblock units. Of the information defined in the H.264 standard, the macroblock information in this embodiment of the invention is information indicating the macroblock partition method and reference mode, and information determining whether to use frame macroblock pairs or field macroblock pairs. The macroblock information is specified using the “mb_type” and “mb_field_decoding_flag” of the H.264 standard. The H.264 motion vector information includes the “refidx” information indicating the reference picture used and a motion vector value indicating the location of the reference picture.

4.2 Header Information Conversion

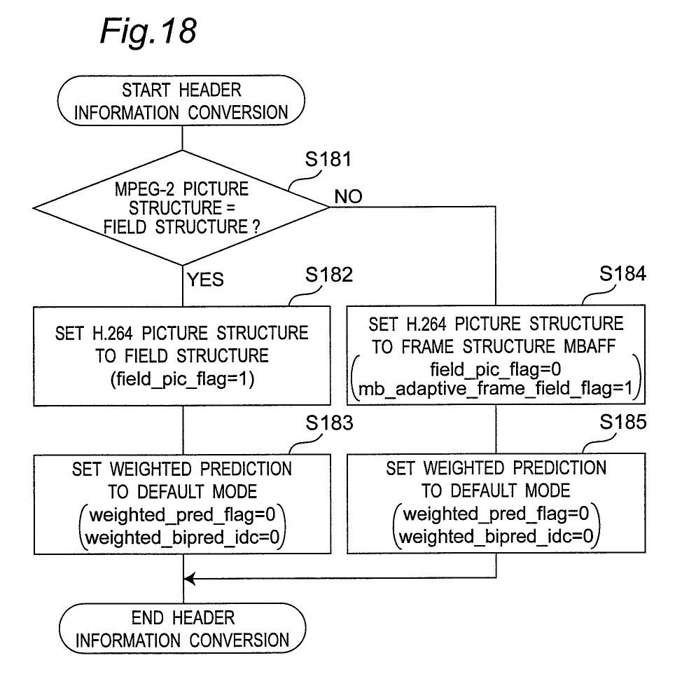

The header information transform unit 501 of the data transform unit 204 converts MPEG-2 header information to H.264 header information as shown in the flow chart in FIG. 18. The header information transform unit 501 first determines if the MPEG-2 picture structure is a field structure based on the MPEG-2 header information (S181).

If the MPEG-2 picture structure is a field structure (S181 returns Yes), the H.264 picture structure is set to a field structure (S182). More specifically, the H.264 “field_pic_flag” is set to 1. Weighted prediction is set to the default mode. (S183). More specifically, “weighted_pred_flag”=“0” and “weighted_bipred_idc”=“0” are set in the H.264 standard.

If the MPEG-2 picture structure is not a field structure (S181 returns No), that is, the picture structure is a frame structure, the H.264 picture structure is set to the H.264 MBAFF frame structure (S184). More specifically, “field_pic_flag”=“0” and “mb_adaptive frame_field_flag”=“1” are set in the H.264 standard. Weighted prediction is set to the default mode (S185). More specifically, “weighted_pred_flag”=“0” and “weighted_bipred_idc”=“0” are set in the H.264 standard.

The MPEG-2 header information is rewritten as H.264 header information by setting the flags as described above.

Because converting the macroblock information and motion vector information differs according to whether the MPEG-2 stream is a field structure or a frame structure, operation is described separately below for field structures and frame structures.

4.3 In Case of Field Structures

The conversion operation of the macroblock information transform unit 502 and the motion vector information transform unit 503 when the MPEG-2 macroblock has a field structure is described below.

4.3.1 Converting Macroblock Information

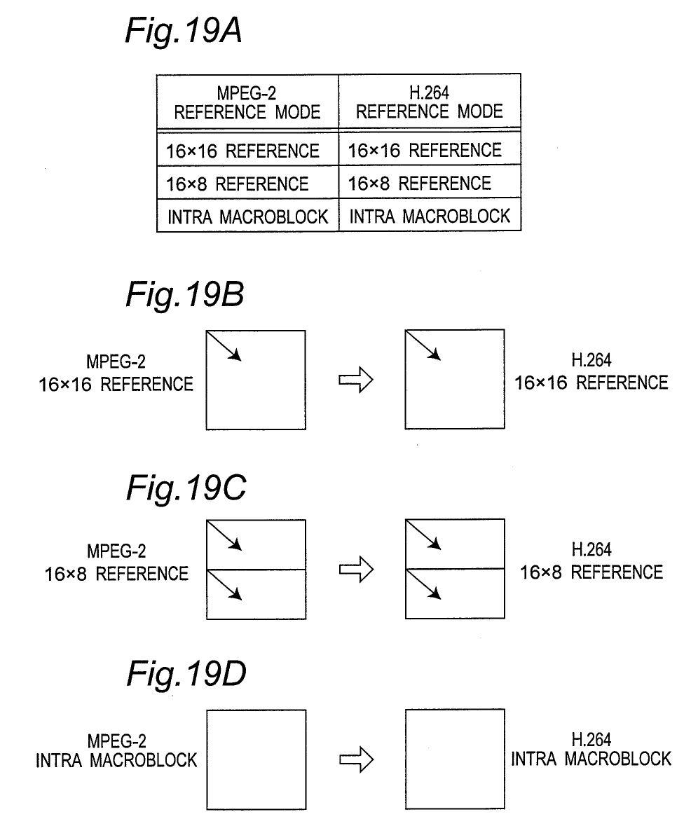

FIG. 19A to FIG. 19D describe macroblock information conversion by the macroblock information transform unit 502. FIG. 19A is a table showing the correlation between the MPEG-2 reference modes and H.264 reference modes when converting from an MPEG-2 reference mode to an H.264 reference mode, and specific examples are shown in FIGS. 19B-19D. FIG. 19B shows conversion in a 16×16 reference mode, FIG. 19C shows conversion in a 16×8 reference mode, and FIG. 19D shows conversion in the intra macroblock reference mode.

When a field structure is used the macroblock partition method is the same in MPEG-2 and H.264 streams, and both MPEG-2 and H.264 streams can be divided into 16×16 pixel macroblocks. As a result, MPEG-2 16×16 macroblocks are converted to H.264 16×16 macroblocks.

The macroblock reference modes are also the same in MPEG-2 and H.264. As shown in FIGS. 19A-19D, MPEG-2 16×16 reference-based blocks are converted to H.264 16×16 reference-based blocks, MPEG-2 16×8 reference-based blocks are converted to H.264 16×8 reference-based blocks, and MPEG-2 intra macroblocks are converted to H.264 intra macroblocks.

By reflecting the results of this transformation in the macroblock information, MPEG-2 macroblock information is changed to H.264 macroblock information.

4.3.2 Converting Motion Vector Information

The motion vector information includes reference information indicating what picture is referenced and a motion vector value indicating the location of the reference picture, and because the MPEG-2 reference mode is converted to the same reference mode in the H.264 standard, the MPEG-2 motion vector value can also be used directly. There is therefore no need to convert the motion vector value.

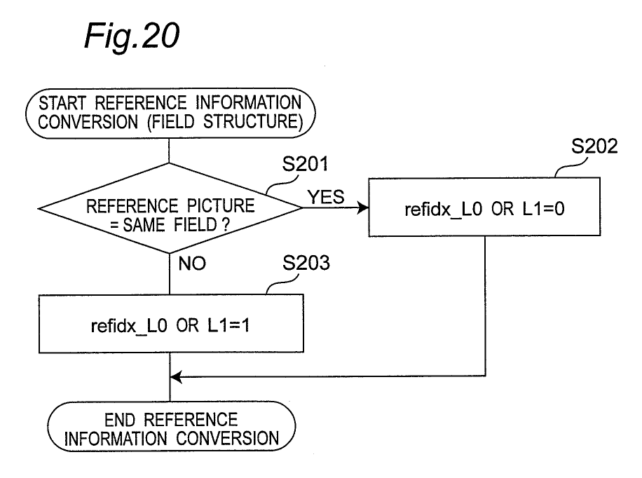

The reference information must be converted to the H.264 standard. FIG. 20 describes the reference information conversion operation of the motion vector information transform unit 503. The motion vector information transform unit 503 determines if the MPEG-2 source reference picture and target reference picture are the same field (S201). More specifically, the motion vector information transform unit 503 determines if both source and target pictures are the top field or the bottom field. If they are the same field, the reference information is set so that the H.264 reference picture is “refidx_L0”=“0” or “refidx_L1”=“0” (S202). If the pictures are different fields, such as if the source reference picture is the top field and the target reference picture is the bottom field, the reference information is set to “refidx_L0”=“1” or “refidx_L1”=“1” (S203). The reference information is thus set so that the MPEG-2 reference picture and the H.264 reference picture are the same.

The H.264 motion vector information is thus generated using the MPEG-2 motion vector value that does not require changing and the converted reference information.

4.4 Frame Structures

The conversion operation of the macroblock information transform unit 502 and the motion vector information transform unit 503 when the MPEG-2 macroblock has a frame structure is described below.

When the macroblock has a frame structure, the partition size and the reference mode are different in MPEG-2 and H.264 as shown in FIG. 7B. More specifically, as will be understood by comparing FIG. 14B and FIG. 16B, the H.264 standard does not have a reference mode of the same size as the 16×16 field reference of the MPEG-2 standard. When using field-based motion prediction in a MPEG-2 frame structure as shown in FIG. 14B, encoding is done separately in a 16×8 top field and a 16×8 bottom field. The H.264 standard does not have a field-based motion prediction mode enabling encoding separately in a 16×8 top field and a 16×8 bottom field, however. H.264 enables separately encoding a 16×16 top field and a 16×16 bottom field by using an MBAFF structure field macroblock pair (32×16) as shown in FIG. 16B. Because a reference mode of the same size used in MPEG-2 frame structure macroblocks may not exist in the H.264 stream, conversion from MPEG-2 to H.264 is more complicated than with a field structure stream.

4.4.1 Converting Macroblock Information and Motion Vector Values in the Motion Vector Information

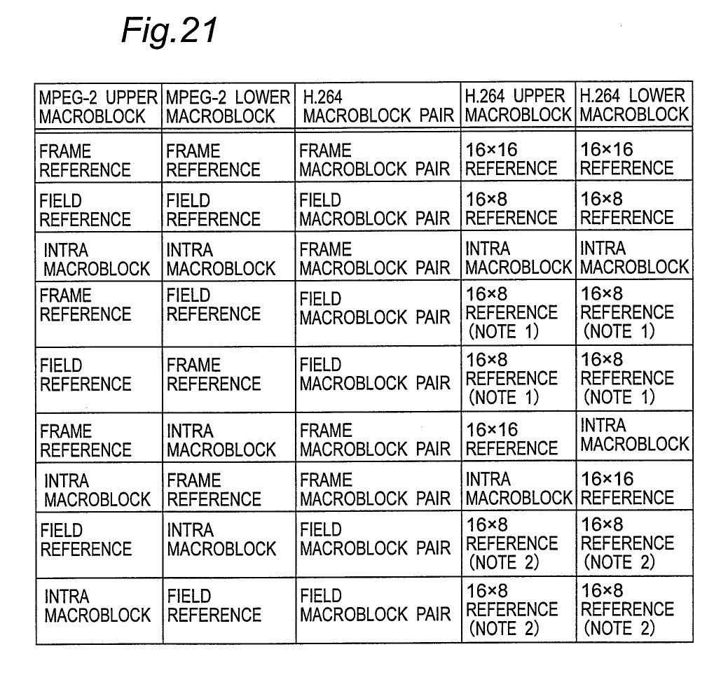

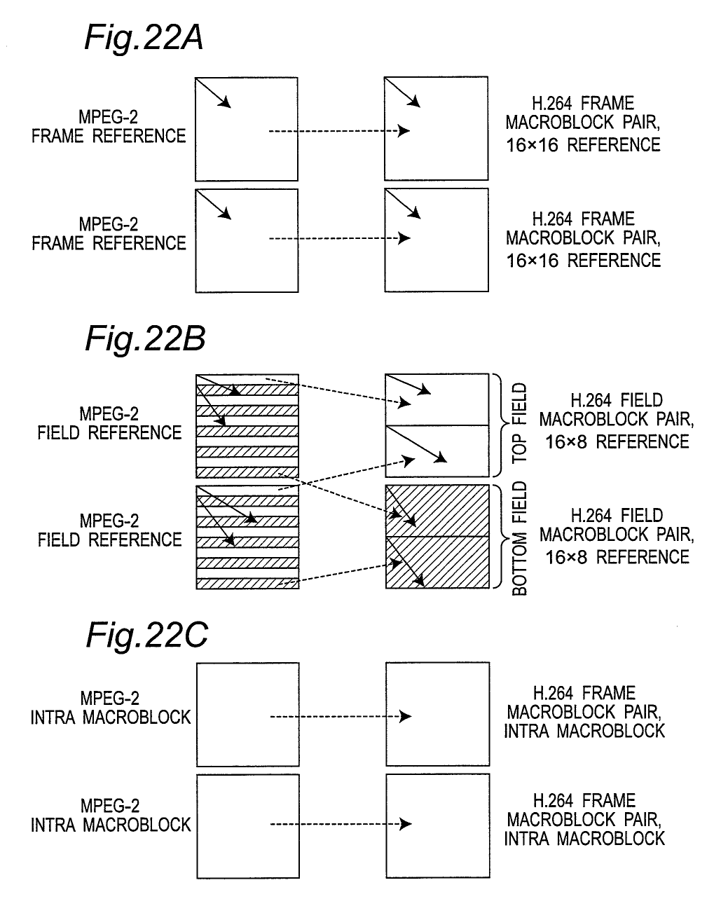

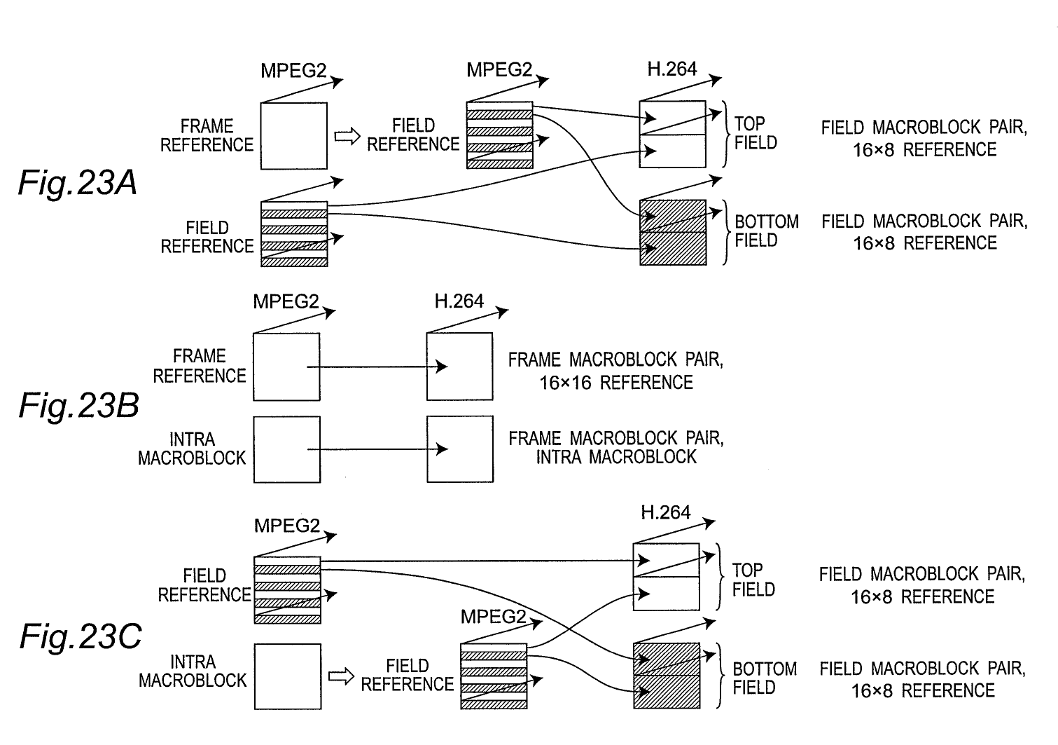

FIG. 21 is a table showing reference mode conversion from MPEG-2 to H.264 when the macroblock has a frame structure. Because H.264 uses the MBAFF structure, conversion from MPEG-2 to H.264 uses a unit of two vertically consecutive MPEG-2 macroblocks. Note 1 in FIG. 21 means that the motion vector is copied and the MPEG-2 frame reference is converted to an H.264 16×8 reference as described below in FIG. 23A. Note 2 in FIG. 21 means that “refidx”=“1” is set and MPEG-2 intra prediction is converted to H.264 16×8 reference as described in FIG. 23C. Specific conversion methods corresponding to the modes shown in FIG. 21 are shown in FIGS. 22A-22C and FIGS. 23A-23C.

FIG. 22A to FIG. 22C show converting the macroblock information when the top and bottom MPEG-2 macroblocks use the same reference mode. FIG. 22A shows a case in which the top and bottom MPEG-2 macroblocks are both frame reference. In this case 16×16 reference macroblocks are selected as the top and bottom H.264 macroblocks. The motion vector values can there be used directly without conversion.

FIG. 22B shows when the top and bottom MPEG-2 macroblocks are field references. In this case the even-line top field of the top MPEG-2 macroblock and the even-line top field of the bottom MPEG-2 macroblock are converted to an H.264 16×16 top field, and the odd-line bottom field of the top MPEG-2 macroblock and the odd-line bottom field of the bottom MPEG-2 macroblock are converted to an H.264 16×16 bottom field. More specifically, a 16×8 reference is selected for the top fields and bottom fields. The motion vector values are the original MPEG-2 motion vector values.

FIG. 22C describes conversion when the top and bottom MPEG-2 macroblocks are intra macroblocks. In this case the intra macroblocks are used as the top and bottom H.264 macroblocks.

FIG. 23A to FIG. 23C describes conversion when different reference modes are used for the top and bottom MPEG-2 macroblocks. FIG. 23A describes conversion when the top MPEG-2 macroblock is frame reference and the lower macroblock is field reference. Field reference conversion in this case results in an H.264 stream having a combination of 16×8 frame reference and 16×8 top field reference, and 16×8 frame reference and 16×8 bottom field reference, but the H.264 stream does not have a 16×8 top field or bottom field. As a result, the MPEG-2 frame reference macroblock is first converted to a field reference macroblock having the same motion vector in the top field and the bottom field. More specifically, the frame reference motion vector is converted directly to motion vector of the top field and the bottom field. This results in top and bottom field reference macroblocks as shown in FIG. 22B that can be converted to 16×8 H.264 field macroblock pairs. More specifically, the 16×8 top fields of the top and bottom MPEG-2 macroblocks are converted to H.264 top fields, and the 16×8 bottom fields of the top and bottom MPEG-2 macroblocks are converted to H.264 bottom fields.

When the top MPEG-2 macroblock is field reference and the lower macroblock is frame reference, the frame reference is converted to a field reference to enable conversion to an H.264 top field and bottom field.

FIG. 23B shows conversion when the top MPEG-2 macroblock is frame reference and the lower macroblock is an intra macroblock. Conversion in this case results in the upper macroblock becoming an H.264 16×16 reference and the lower macroblock becoming an intra macroblock. The frame reference motion vector value can be used without conversion in this case. The operation applies when the upper macroblock is an intra macroblock and the lower macroblock is frame reference.

FIG. 23C shows the case when the top MPEG-2 macroblock is field reference-based and the lower macroblock is an intra macroblock. As described above the MPEG-2 field reference can be partitioned into a 16×8 top field and bottom field, but the H.264 does not allow for a 16×8 top field and bottom field. Macroblocks can therefore not be constructed using a combination of a 16×8 top field or bottom field and a 16×8 intra macroblock. The intra macroblock is therefore converted to the field reference of an inter macroblock by adding a motion vector to the MPEG-2 intra macroblock without applying motion detection. This motion vector can be any value. The motion vector can, for example, be 0 MV or pMV (a predicted motion vector). The code size can be minimized by using an inter macroblock with a motion vector equal to pMV.

If the intra macroblock is converted to an inter macroblock without motion detection, the code size of the 16×8 reference blocks in the inter macroblock after conversion may increase and the bit rate increase. This is not a problem with respect to the standard, however. By converting an intra macroblock to a field reference inter macroblock, the top and bottom MPEG-2 macroblocks become field reference. Conversion to H.264 top and bottom fields is therefore possible as shown in FIG. 22 (b). The same conversion applies when the upper macroblock is an intra macroblock and the lower macroblock is field reference-based.

4.4.2 Converting the Reference Information of the Motion Vector Information

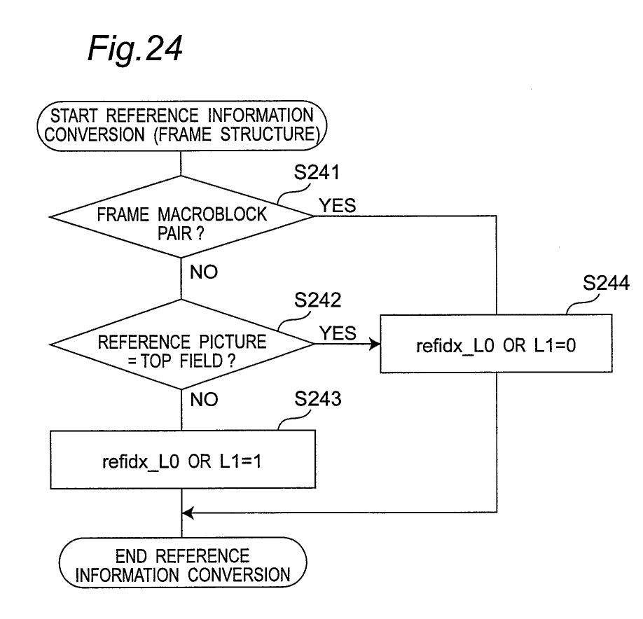

FIG. 24 shows a method whereby the motion vector information transform unit 503 converts the reference information of the motion vector information. The motion vector information transform unit 503 first determines if the MPEG-2 macroblocks were converted to an H.264 frame macroblock pair (S241). If they were converted to a frame macroblock pair, the reference information is set so that the “refidx_L0”=“0” or “refidx_L1”=“0” picture is the reference picture (S244). If not converted to a frame macroblock pair, that is, if converted to a field macroblock pair, the motion vector information transform unit 503 determines whether the reference picture that is the picture of the reference target is the top field (S242). If it is the top field, the reference information is set to “refidx_L0”=“0” or “refidx_L1”=“0” (S244). If not the top field, that is, if the bottom field, the reference information is set to “refidx_L0”=“1” or “refidx_L1”=“1” (S243). This completes conversion of the reference information.

As described above, this embodiment of the invention converts all of the header information, macroblock information, and motion vector information for the MPEG-2 stream macroblocks of both MPEG-2 field structures and frame structures to H.264 header information, macroblock information, and motion vector information according to the macroblock partition method and reference mode. More specifically, the motion vector values contained in the motion vector information before conversion are used as the motion vector values after conversion. There is therefore no loss of image quality in the H.264 stream after conversion. Furthermore, because the pre-conversion motion vector values are used without conversion, a computationally intensive motion detection process is not required. The circuit size can therefore be reduced and a low production cost can be achieved.

Furthermore, when the same reference mode is not available in both MPEG-2 and H.264 streams, such as with the MPEG-2 frame structure, direct conversion from MPEG-2 to H.264 is not possible when only one of the top and bottom MPEG-2 macroblocks is field reference-based. However, when there is a combination of field reference and frame reference macroblocks, or field reference and intra macroblocks, this embodiment of the invention converts the frame reference and intra macroblocks to field reference macroblocks. Conversion from MPEG-2 to H.264 is therefore possible even when only one of the upper and lower macroblocks is field reference-based. Because the motion vector value of the frame reference macroblock is used when converting a frame reference macroblock to a field reference macroblock, motion detection is not necessary and the circuit size can be reduced. Because motion detection is also not performed when converting an inter macroblock to a field reference macroblock, the circuit size can be further reduced.

5. Variations

This embodiment of the invention uses “refidx_L0”=“0” or “refidx_L0”=“1” when the reference picture looks forward, but the invention is not so limited. Likewise, this embodiment of the invention uses “refidx_L1”=“0” or “refidx_L1”=“1” when the reference picture looks backward, but the invention is not so limited. More particularly, any value can be used as required within the range of values defined in the H.264 standard.

The H.264 encoder 206 has a variable length coding unit 406 and uses variable length coding, but arithmetic coding as defined in the H.264 standard can be used instead of variable length coding.

The transcoder 104 can be rendered entirely as a software construction or a hardware construction. In addition, any part of the transcoder 104 can be rendered as a software construction.

This embodiment of the invention reads and transcodes an MPEG-2 stream from the storage device 101 in FIG. 1, and writes the resulting H.264 stream to the storage device 101, but the MPEG-2 stream can be acquired from a broadcast signal or other communication path and transcoded. The H.264 stream can also be output to a LAN (local area network) instead of written to the storage device 101.

### Embodiment 2

A second embodiment of the H.264 encoder 206 in the transcoder 104 in FIG. 2 is described next. While the H.264 encoder 206 in the first embodiment does not detect motion, the H.264 encoder of this embodiment detects motion only near the position indicated by the motion vector information in order to improve pixel accuracy.

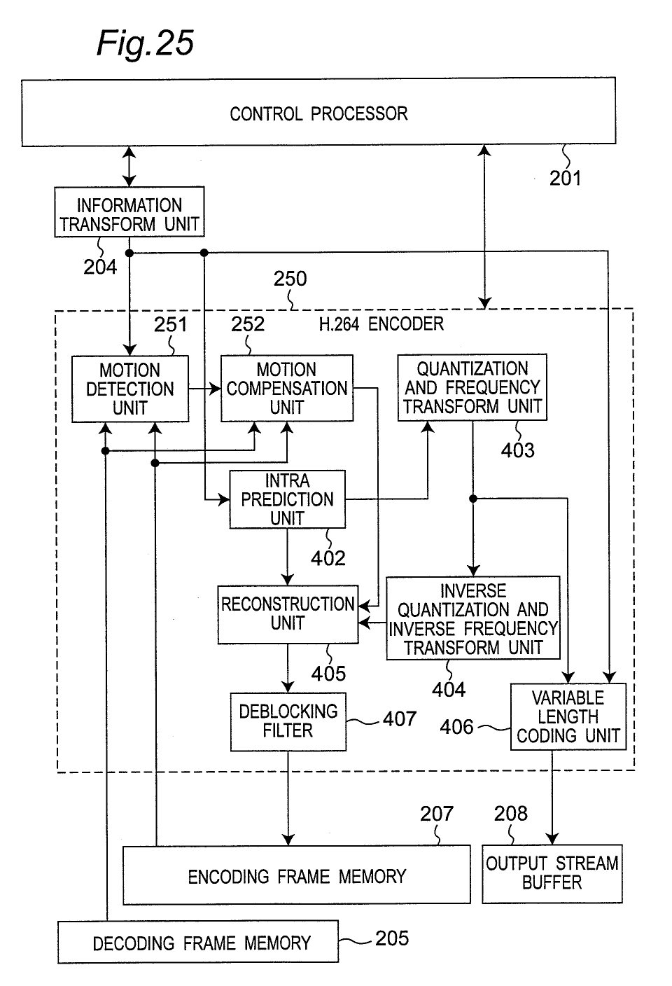

FIG. 25 shows the arrangement of the H.264 encoder 250 according to this embodiment of the invention. The H.264 encoder 250 according to this embodiment of the invention differs from the H.264 encoder 206 of the first embodiment in that this H.264 encoder 250 has a motion detection unit 251 and a motion compensation unit 252 that operates differently from the motion compensation unit of the first embodiment. Parts in the H.264 encoder 250 of this embodiment that operate the same as the H.264 encoder 206 of the first embodiment are identified by the same reference numerals, and further description thereof is omitted. The motion detection unit 251 and the motion compensation unit 252 are described next.

The motion detection unit 251 receives the header information, macroblock information, and motion vector information from the data transform unit 204. When encoding to an inter macroblock is indicated by the data transform unit 204, such as encoding a 16×16 reference is selected, the motion detection unit 251 selects the reference picture pointed to by the motion vector information from the encoding frame memory 207, and gets the image data neighboring the position indicated by the motion vector information. The motion detection unit 251 also computes the position with the highest correlation to the decoded image read from the decoding frame memory 205 at the same time. The position with the highest correlation is the position with the smallest SAD (Sum of Absolute Difference) The macroblock information and motion vector information based on the computed result is output to the motion compensation unit 252.

Based on the macroblock information and motion vector information received from the motion detection unit 251, the motion compensation unit 252 gets the image data at the position pointed to by the motion vector information from the encoding frame memory 207, applies the H.264 filter operation, and computes the position of the reference picture with decimal accuracy. The motion compensation unit 252 also outputs the difference data between this reference picture and the decoded image read from the decoding frame memory 205 to the quantization and frequency transform unit 403, and outputs the reference picture to the reconstruction unit 405.

The motion detection unit 251 and the motion compensation unit 252 operate when the data transform unit 204 tells the H.264 encoder 250 to encode to an inter macroblock. The operation is the same when the data transform unit 204 specifies a different reference mode, such as 16×8 reference. Operation when the data transform unit 204 instructs the H.264 encoder 250 to encode to an intra macroblock is the same as described in FIG. 4 in the first embodiment.

Because MPEG-2 only contains motion vector information to half pel precision, only half pel precision can be achieved in the transcoded H.264 stream if the motion vector information is used as is. More specifically, the first embodiment affords only half pel precision is afforded in the H.264 stream. However, this second embodiment of the invention can use the 0.25 pel motion vector information afforded by the H.264 standard as a result of the motion detection unit 251 searching only near the position pointed to by the MPEG-2 motion vector information. The initial position searched for motion detection can therefore be set with good precision. In addition, because motion vector information is used as described in the first embodiment, it is not necessary to detect motion over a wide area. Circuit size can therefore be reduced and a low cost can be achieved.

A two tap filter is used in MPEG-2 and a six tap filter is used in H.264 to compute motion with 0.5 pel accuracy. The motion vector may therefore be optimal for MPEG-2 but not optimal for H.264. This embodiment of the invention applies motion detection, however, and can therefore compute the optimal motion vector.

Note that while the motion detection unit 251 and motion compensation unit 252 are rendered separately in this embodiment, the motion detection unit 251 can contain the function of the motion compensation unit 252.

### Embodiment 3

1. Transcoder Configuration

Another configuration of the transcoder 104 in FIG. 1 is described next. The transcoder 104 decodes the MPEG-2 picture, restores the original image from a difference image, and then re-encodes a H.264 picture. In order to reduce the decoding and encoding operations, the transcoder 104 according to this embodiment of the invention transcodes to an H.264 picture from the difference image without returning the MPEG-2 picture to the original image.

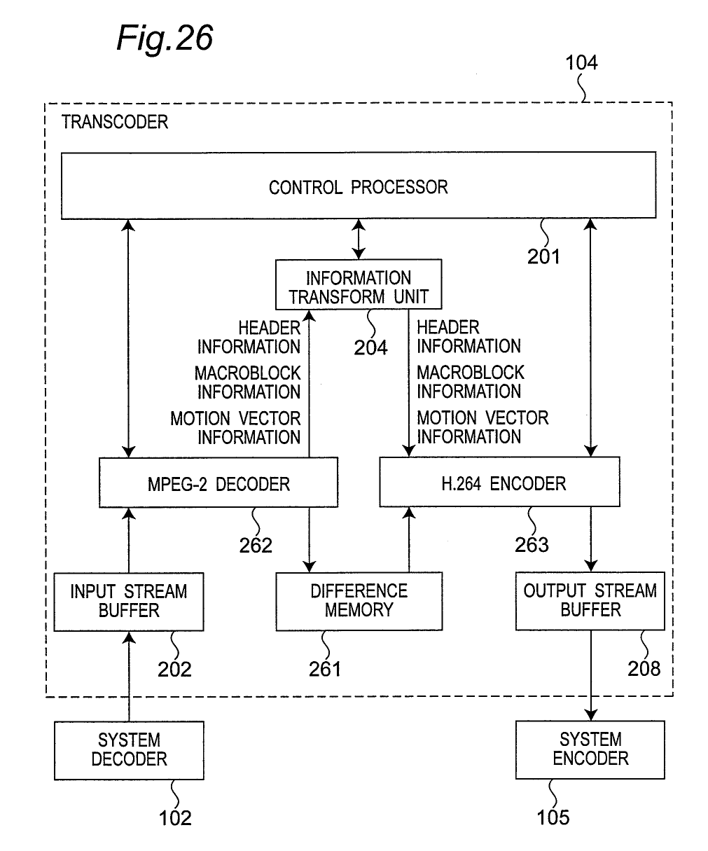

FIG. 26 shows the internal configuration of the transcoder 104 in this embodiment of the invention. Like parts in this and the first embodiment are identified by the same reference numerals in FIG. 26, and further description thereof is omitted. The transcoder 104 in the first embodiment has a decoding frame memory 205 and encoding frame memory 207, but the transcoder 104 in this embodiment has a difference memory 261 instead of a decoding frame memory 205 and encoding frame memory 207. The difference memory 261 stores the difference data after variable length decoding, inverse quantization, and inverse frequency transformation. An H.264 encoder 263 also reads the difference data stored by the difference memory 261. The MPEG-2 decoder 262 and the H.264 encoder 263 of this embodiment also differ from the MPEG-2 decoder 203 and H.264 encoder 206 of the first embodiment. The internal configuration of the MPEG-2 decoder 262 and the H.264 encoder 263 are further described below.

The operation of the transcoder 104 is described next. The MPEG-2 decoder 262 reads and decodes the stream from the input stream buffer 202. The difference data after variable length decoding, inverse quantization, and inverse frequency transformation by the MPEG-2 decoder 262 is stored in the difference memory 261. The MPEG-2 decoder 262 also outputs the header information, macroblock information, and motion vector information for each macroblock to the data transform unit 204.

The data transform unit 204 converts the MPEG-2 header information, macroblock information, and motion vector information to H.264 standard header information, macroblock information, and motion vector information, and inputs the converted information to the H.264 encoder 263. This transformation operation is described in detail below.

The H.264 encoder 263 reads the difference data after variable length decoding, inverse quantization, and inverse frequency transformation, H.264 encodes the difference data, and outputs the encoded H.264 stream to the output stream buffer 208. The output stream buffer 208 outputs the stream to the system encoder 105.

1.1 Internal Configuration of the MPEG-2 Decoder

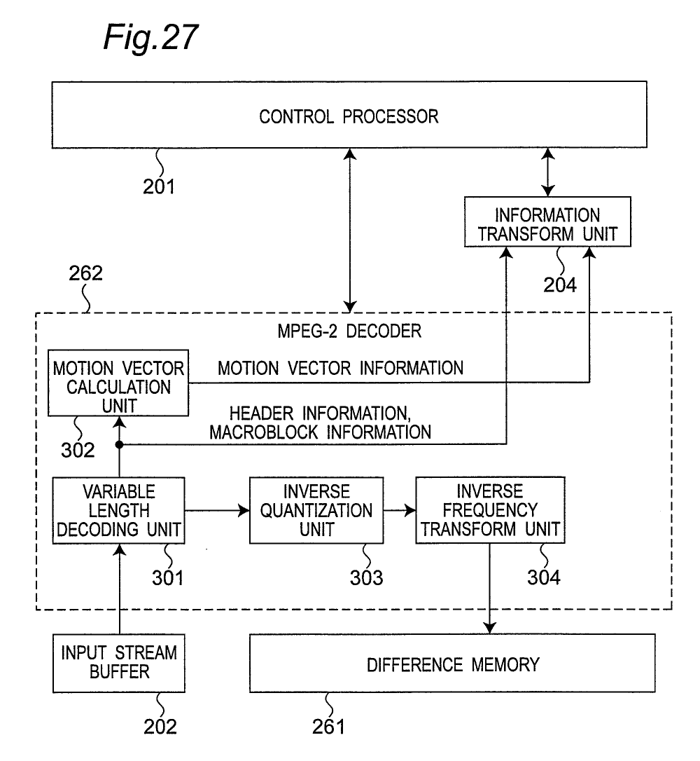

FIG. 27 shows the internal configuration of the MPEG-2 decoder 262 shown in FIG. 26. The MPEG-2 decoder of this embodiment differs from the MPEG-2 decoder 203 of the first embodiment in that the motion compensation unit 305 and reconstruction unit 306 are not present. This MPEG-2 decoder 262 is otherwise identical to the MPEG-2 decoder 203 of the first embodiment. The operation of the MPEG-2 decoder 262 in this embodiment is described next.

When decoding an intra macroblock the header information and variable length decoded macroblock information are output to the data transform unit 204. The variable length decoded DCT coefficient is inverse quantized by the inverse quantization unit 303 and inverse frequency transformed by the inverse frequency transform unit 304, and output to the difference memory 261. Because an intra macroblock does not have a prediction picture in MPEG-2, the values output to the difference memory 261 are the pixel data.

When decoding a P picture and B picture inter macroblock, header information and the macroblock information from the variable length decoded data are output to the data transform unit 204. The motion vector value of the motion vector information is converted to the actual motion vector value using the prediction value by the motion vector calculation unit 302 and output to the data transform unit 204. The variable length decoded DCT coefficient is inverse quantized by the inverse quantization unit 303, inverse frequency transformed by the inverse frequency transform unit 304, and output to the difference memory 261.

1.2 Internal Configuration of the H.264 Encoder

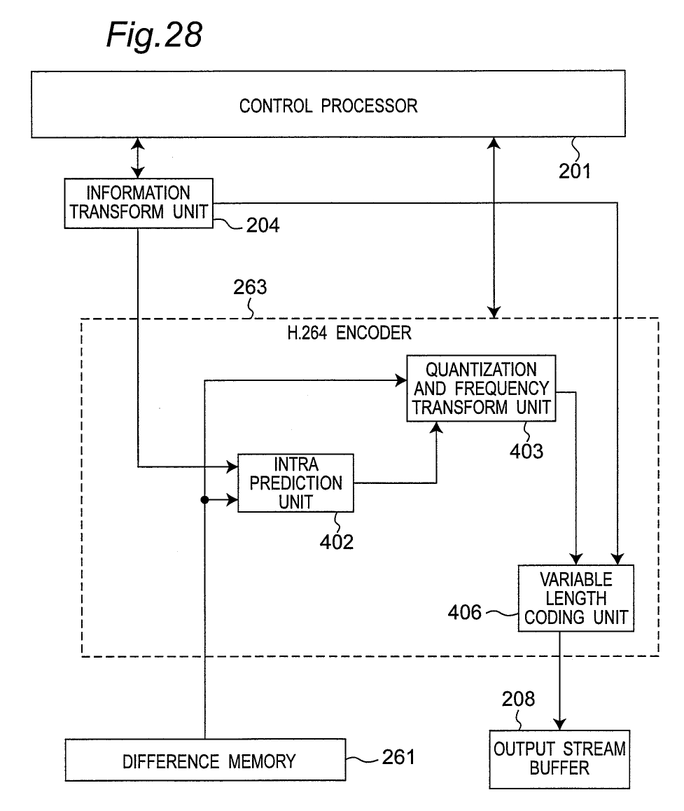

FIG. 28 shows the internal configuration of the H.264 encoder 263 shown in FIG. 26. The H.264 encoder 263 in this embodiment of the invention differs from the H.264 encoder 206 in the first embodiment in that it does not have a motion compensation unit 401, a reconstruction unit 405, a deblocking filter 407, and an inverse quantization and inverse frequency transform unit 404.

H.264 header information and the H.264 macroblock information and H.264 motion vector information for the macroblock to be encoded are input from the data transform unit 204 to the H.264 encoder 263.

The difference predicted from the pixels of the macroblock adjoining the intra macroblock being encoded is encoded in intra prediction, but because the picture stored in the difference memory 261 in this embodiment is a difference image when encoding an inter macroblock, an inter macroblock cannot be used for intra prediction. The pixels of an inter macroblock are therefore not used for intra prediction. The H.264 encoder 263 therefore operates in a constrained intra prediction mode, that is, the “constrained_intra prediction_flag”=“1”. Only the pixel values of the intra macroblock are used for the pixels used for intra prediction in this constrained intra prediction mode, and inter macroblock pixel values are not used.

When the data transform unit 204 instructs the H.264 encoder 263 to encode to an intra macroblock, the difference data read from the difference memory 261 is input to the intra prediction unit 402 for intra prediction. When the data transform unit 204 instructs the H.264 encoder 263 to encode to an intra macroblock, the MPEG-2 macroblock is also always an intra macroblock, and the difference data read from the difference memory 261 are the pixel values. This embodiment of the invention does not decode the pixel value data for inter macroblocks, but because the H.264 encoder 263 uses the constrained intra prediction mode, only the values of the pixels around the intra macroblock to be encoded and the pixels in the intra macroblock are used for this intra prediction.

The intra prediction unit 402 applies intra prediction as defined in the H.264 standard, determines the prediction direction, and outputs the difference data between the predicted picture and the decoded image to the quantization and frequency transform unit 403. The quantization and frequency transform unit 403 applies quantization and frequency transformation operations, and outputs to the variable length coding unit 406. The variable length coding unit 406 encodes the frequency transformed difference signal, and outputs to the output stream buffer 208.

2.1 Header Information Conversion

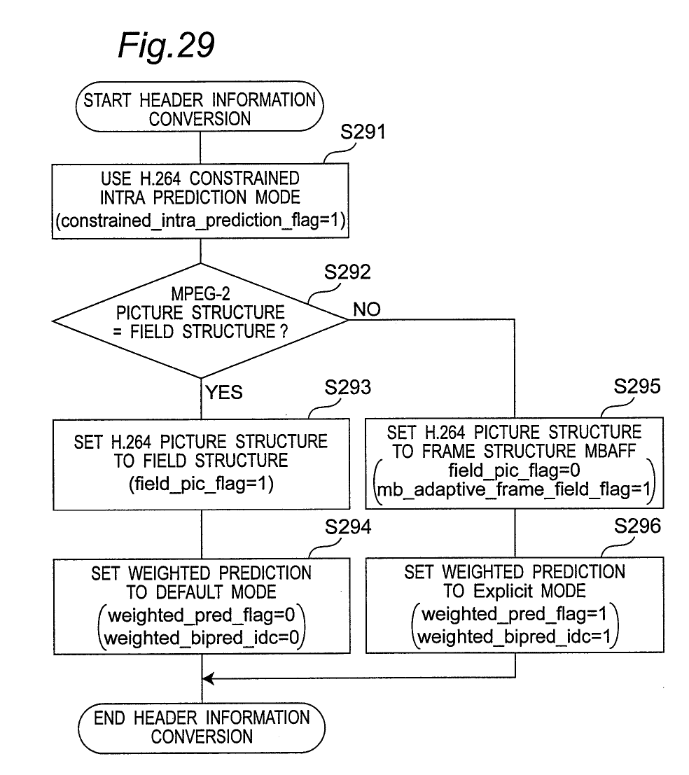

The header information transform unit 501 of the data transform unit 204 converts the MPEG-2 header information to H.264 header information as shown in the flow chart in FIG. 29.

The header information transform unit 501 always uses the constrained intra prediction mode, that is, “constrained_intra_prediction_flag”=“1” (S291). The header information transform unit 501 then determines if the MPEG-2 picture structure is a field structure (S292).

If the MPEG-2 picture structure is a field structure, the H.264 picture structure is converted to a field structure (S293). More specifically, the H.264 “field_pic_flag” is set to “1”. Weighted prediction is set to the default mode (S294). More specifically, the H.264 “weighted_pred_flag”=“0” and the “weighted_bipred_idc”=“0”.

If the MPEG-2 picture structure is not a field structure, that is, if it is a frame structure, the H.264 picture structure is set to the MBAFF (Macro Block Adaptive Frame Field) of the frame structure (S295). More specifically, the H.264 “field_pic_flag”=“0” and the “mb_adaptive_frame_field_flag”=“1”. Weighted prediction is set to the Explicit mode (S296). More specifically, the H.264 “weighted_pred_flag”=“1” and “weighted_bipred_idc”=“1”.

2.2 Converting Macroblock Information and Motion Vector Information

The conversion operation of the macroblock information transform unit 502 and motion vector information transform unit 503 are described next. Operation is the same as the first embodiment in the case of an MPEG-2 field structure, and description thereof is thus omitted.

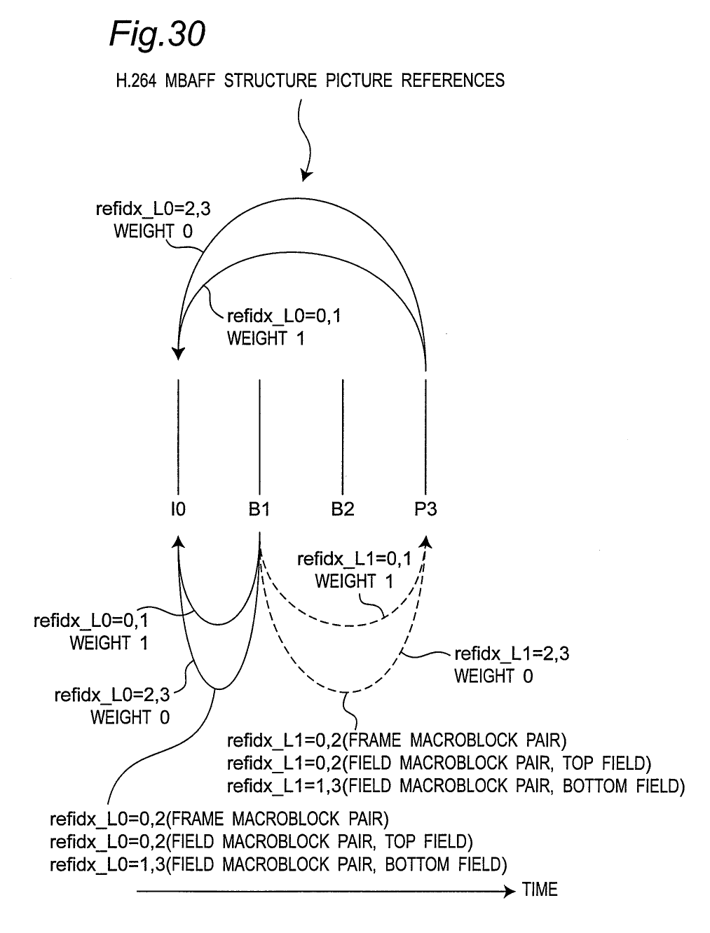

The reference pictures for an MPEG-2 frame structure are described below. The MPEG-2 frame structure shown in FIG. 15 is converted to the pictures of the H.264 frame structure shown in FIG. 30. The picture indices are the same as in FIG. 15.

In FIG. 30 picture P3 references past picture I0 as “refidx_L0”=0, 1, 2, or 3. Picture B1 references past picture I0 and future picture P3 as “refidx_L0”=0, 1, 2, or 3, and “refidx_L1”=0, 1, 2, or 3, respectively. More specifically, a frame macroblock pair uses “refidx_L0”=0, 2 or “refidx_L1”=0, 2. A field macroblock pair uses “refidx_L0”=0, 2 or “refidx_L1”=0, 2 when referencing a top field, and “refidx_L0”=1, 3 or “refidx_L1”=1, 3 when referencing a bottom field.

The reason a different “refidx” value is assigned even though the reference pictures are the same is that the Explicit weighted prediction mode is used and different weighting is used for the same reference picture. When using weighted prediction, “reference picture×weight” is the pel value of the reference picture.

When “refidx_L0”=0 or 1 or “refidx_L1”=0 or 1 is used, weighting is set as follows so that the weighting is the same as in the default mode. When referencing one side of a P picture or B picture, weight=1. When referencing both directions of a B picture, weight=0.5 for referencing in both directions.

If “refidx_L0”=2 or 3 or “refidx_L1”=2 or 3 is used, weight=0. As a result, if “refidx_L0” or “refidx_L1”=2 or 3, the pixel values of the reference picture are always “0”.

Conversion from a MPEG-2 frame structure is the same as conversion in the first embodiment except when the combination of upper and lower macroblocks is an intra macroblock and field reference. The conversion that is different from the conversion in the first embodiment, that is, when the upper macroblock is field reference and the lower macroblock is an intra macroblock, is described next.

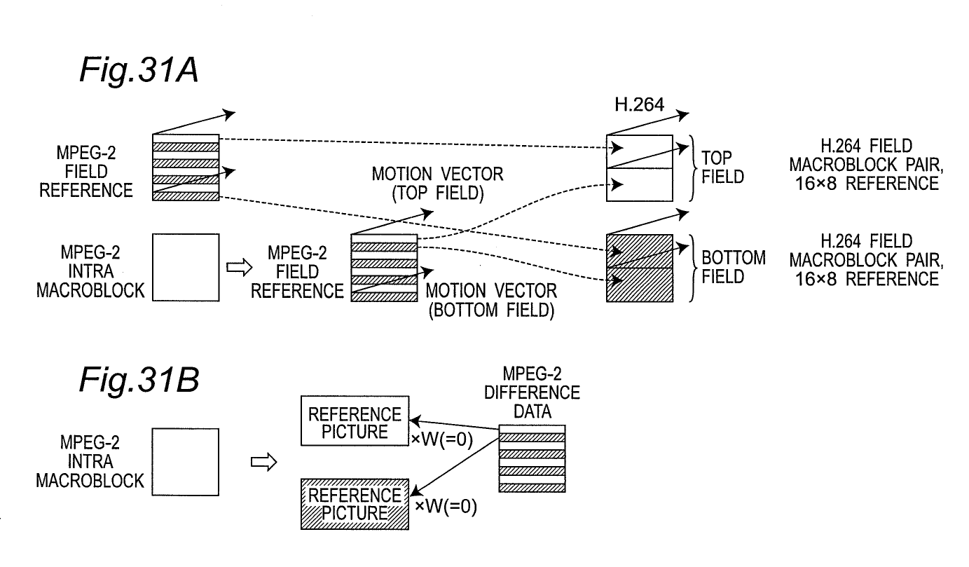

FIG. 31A describes conversion when the upper macroblock is field reference and the lower macroblock is an intra macroblock, and FIG. 31B describes converting from an MPEG-2 intra macroblock to a field reference-based macroblock. If a 16×16 field reference-based macroblock is encoded separately as a top field and a bottom field, the upper half of the H.264 macroblock will be a 16×8 intra macroblock (top field or bottom field) and the lower half will be an inter macroblock. However, this macroblock structure does not exist in the H.264 standard. As shown in FIG. 31A, therefore, the field based macroblock is converted to an inter macroblock with a reference picture by adding motion vector information to an intra macroblock that does not have a reference picture. This motion vector can be any value, but the code size can be minimized in H.264 by using an inter macroblock with a motion vector equal to pMV (motion vector prediction value).

Unlike the first embodiment, the transcoder 104 in this embodiment does not have an encoding frame memory 207. More specifically, there is no local decoded image for a past frame. A local decoded image therefore cannot be used as the reference picture. There is also no decoding frame memory 205. As a result, a decoded image (picture to encode) cannot be read from the decoding frame memory 205. The difference between the decoded image and reference picture therefore cannot be generated. Motion vector information for making the intra macroblock into field reference therefore cannot be generated, and the intra macroblock cannot be converted directly to an inter macroblock.

This embodiment of the invention therefore uses a reference with weight=0 to convert the intra macroblock to an inter macroblock. More specifically, “refidx_L0” and “refidx_L1”=2 or 3. The difference data stored in the difference memory 261 is the data acquired by computing (difference data=decoded image−reference picture×weight W). As a result, if weight W=0, then the difference data equals the decoded image. The intra macroblock can be converted to a field reference-based macroblock by adding a motion vector to this difference data. If weight W=0, the MPEG-2 difference data (=decoded image) is the same as the H.264 difference data.

This operation results in the upper and lower parts of the field macroblock pair being field reference-based, and the upper and lower MPEG-2 macroblocks being convertible to the H.264 top field and bottom field. Operation is the same when the upper macroblock is an intra macroblock and the lower macroblock is field reference.

As described above, this embodiment of the invention stores the difference data after inverse frequency transforming the MPEG-2 encoded data, and H.264 encodes the stored difference data according to the partition method and reference mode of the H.264 macroblocks converted by the data transform unit. Transcoding is therefore possible without using a reference picture when the upper and lower MPEG-2 macroblocks are a combination of field reference-based and intra macroblocks by using zero weighting and applying a simple transform to the motion vector information.

### Embodiment 4

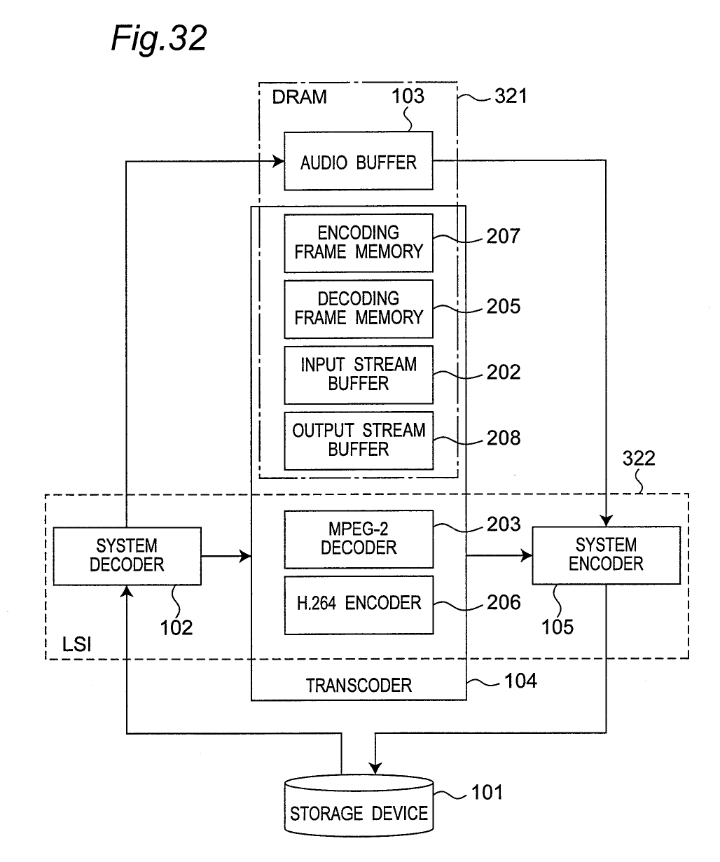

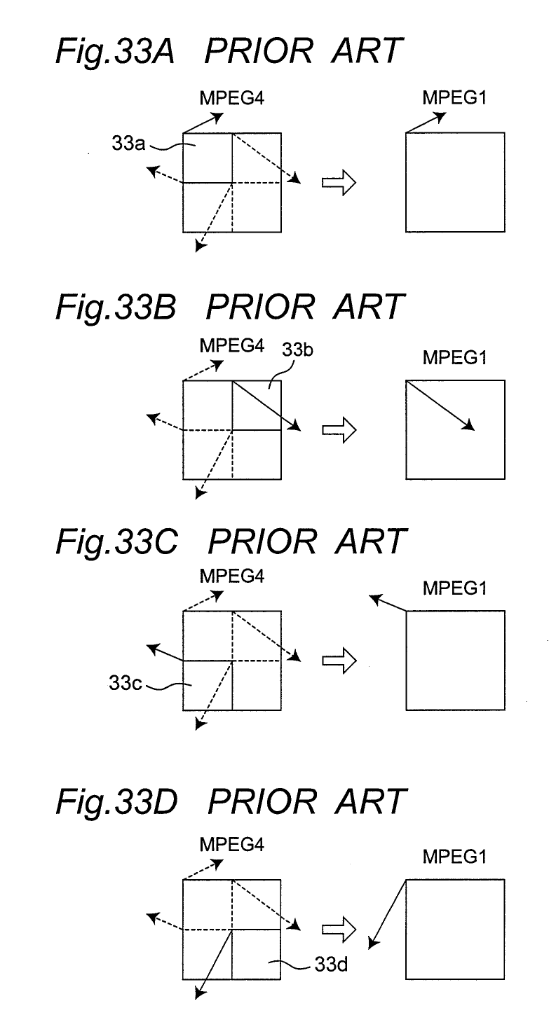

A preferred embodiment of a transcoding apparatus is described next. FIG. 32 is a block diagram of a transcoding apparatus according to this embodiment of the invention. Parts that are the same as in FIG. 1 and FIG. 2 are identified by the same reference numerals in FIG. 32. In this embodiment of the invention the system decoder 102, MPEG-2 decoder 203, H.264 encoder 206, and system encoder 105 are rendered in a single LSI device 322, and the audio buffer 103, decoding frame memory 205, encoding frame memory 207, input stream buffer 202, and output stream buffer 208 that require relatively large storage capacity are rendered in a single DRAM device 321.

The system decoder 102, MPEG-2 decoder 203, H.264 encoder 206, and system encoder 105 function blocks are typically rendered by an LSI device, which is an integrated circuit device. These parts can be rendered individually as single chips, or as a single chip containing some or all of these parts. While an LSI device is referred to here, the actual device may be referred to as an IC device, a system LSI device, a super LSI device, or an ultra LSI device, for example, depending on the degree of integration. The method of circuit integration is also not limited to an LSI device, and a dedicated circuit or general purpose processor can be used. An FPGA (field programmable gate array) that can be programmed after LSI manufacture, or a reconfigurable processor that enables reconfiguring the connections and settings of the circuit cells in the LSI device can alternatively be used.

Furthermore, if circuit integration technologies that replace LSI emerge as a result of advances in semiconductor technology or separate emerging technologies, such technologies can obviously be used to integrate the same function blocks. It may be possible to use biotechnology, for example.

The foregoing embodiments describe conversion from MPEG-2 to H.264, but the invention is not limited to these coding standards, and the invention includes transcoding from a coding specification having a data structure similar to MPEG-2 to a coding specification having a data structure similar to H.264.

The transcoding apparatus and transcoding method of the invention enable converting from the MPEG-2 standard to the H.264 standard at low cost while reducing the circuit size, and can be used in DVD recorders and hard disk recorders for recording MPEG and other types of compressed video. Furthermore, because the invention can reduce the bit rate by converting an MPEG or other compressed data stream to a more efficient compression standard, the invention can also be used in devices that transmit data over a network.

Although the present invention has been described in connection with specified embodiments thereof, many other modifications, corrections and applications are apparent to those skilled in the art. Therefore, the present invention is not limited by the disclosure provided herein but limited only to the scope of the appended claims. The present disclosure relates to subject matter contained in Japanese Patent Application No. 2006-290934, filed on Oct. 26, 2006, which is expressly incorporated herein by reference in its entirety.

What is claimed is:

1. A transcoding apparatus that converts an encoding standard of encoded image data, comprising:
a decoding unit that decodes data encoded according to a first encoding standard;
a transformation unit that receives picture structure information and macroblock referencing information input from the decoding unit, and converts the picture structure information and the macroblock referencing information to picture structure information and macroblock referencing information according to a second encoding standard; and
an encoding unit that encodes the data decoded by the decoding unit according to the second encoding standard using the picture structure information and macroblock referencing information which were converted by the transformation unit.

2. The transcoding apparatus according to claim 1, wherein:
the transformation unit sets the picture structure of the second encoding standard to a field structure when the picture structure of the first encoding standard is a field structure; and
sets the picture structure of the second encoding standard to a frame structure and an MBAFF structure when the picture structure of the first encoding standard is a frame structure.

3. The transcoding apparatus according to claim 1, wherein:
when two vertically consecutive macroblocks in the frame structure of the first encoding standard are frame-reference-based and field-reference-based, the transformation unit converts the macroblocks of the first encoding standard to a field macroblock pair of two 16×8-reference-based macroblocks of the second encoding standard.

4. The transcoding apparatus according to claim 3, wherein:
the transformation unit converts the frame-reference-based macroblock to field-reference-based macroblock, and then converts two macroblocks of the first encoding standard to a field macroblock pair of two 16×8-reference-based macroblocks of the second encoding standard.

5. The transcoding apparatus according to claim 1, wherein:
when two vertically consecutive macroblocks in the frame structure of the first encoding standard are an intra macroblock and a field-reference-based macroblock, the transformation unit converts the intra macroblock to an inter macroblock, and then converts the two vertically consecutive macroblocks in the frame structure of the first encoding standard to a field macroblock pair of two 16×8-reference-based macroblocks of the second encoding standard.

6. The transcoding apparatus according to claim 5, wherein:
the transformation unit converts the intra macroblock to an inter macroblock with a motion vector equal to pMV.

7. The transcoding apparatus according to claim 1, further comprising:
a storage unit that stores data decoded by the decoding unit;
wherein the encoding unit applies motion compensation to data stored by the storage unit according to macroblock referencing information converted by the transformation unit without applying motion detection.

8. The transcoding apparatus according to claim 1, further comprising:
a storage unit that stores data decoded by the decoding unit;
wherein the encoding unit applies motion detection to data stored by the storage unit according to macroblock referencing information converted by the transformation unit.

9. A transcoding apparatus that converts the encoding standard of encoded image data, comprising:
a decoding unit that decodes data encoded according to a first encoding standard, applies an inverse frequency transform to the decoded data, and outputs difference data;
a memory that stores the difference data;
a transformation unit that receives picture structure information and macroblock referencing information input from the decoding unit, and converts the picture structure information and the macroblock referencing information to picture structure information and macroblock referencing information according to a second encoding standard; and
an encoding unit that encodes the difference data in the memory according to the second encoding standard using the picture structure information and macroblock referencing information which were converted by the transformation unit.

10. The transcoding apparatus according to claim 9, wherein:
the transformation unit sets the picture structure of the second encoding standard to a field structure when the picture structure of the first encoding standard is a field structure; and
sets the picture structure of the second encoding standard to a frame structure and an MBAFF structure when the picture structure of the first encoding standard is a frame structure.

11. The transcoding apparatus according to claim 9, wherein:
when two vertically consecutive macroblocks in the frame structure of the first encoding standard are frame-reference-based and field-reference-based, the transformation unit converts the macroblocks of the first encoding standard to a field macroblock pair of two 16×8-reference-based macroblocks of the second encoding standard.

12. The transcoding apparatus according to claim 9, wherein:
when two vertically consecutive macroblocks in the frame structure of the first encoding standard are an intra macroblock and a field-reference-based macroblock, the transformation unit converts the intra macroblock to an inter macroblock, and then converts the two vertically consecutive macroblocks in the frame structure of the first encoding standard to a field macroblock pair of two 16×8-reference-based macroblocks of the second encoding standard.

13. The transcoding apparatus according to claim 12, wherein:
the transformation unit converts the intra macroblock to an inter macroblock that weights the reference picture zero.

14. The transcoding apparatus according to claim 12, wherein:
the transformation unit converts the intra macroblock to an inter macroblock with a motion vector equal to pMV.

15. A transcoding method that converts an encoding standard of encoded image data, comprising:
decoding data encoded according to a first encoding standard;
converting picture structure information and macroblock referencing information acquired from the decoding step to picture structure information and macroblock referencing information according to a second encoding standard; and
encoding the data decoded by the decoding step according to the second encoding standard using the picture structure information and macroblock referencing information which were converted by the converting step.

16. A transcoding method that converts the encoding standard of encoded image data, comprising:
decoding data encoded according to a first encoding standard;
storing difference data after an inverse frequency transform is applied by the decoding step;
converting the picture structure information and the macroblock referencing information acquired from the decoding step to picture structure information and macroblock referencing method information according to a second encoding standard; and
encoding the difference data stored in the storage step according to the second encoding standard using the picture structure information and macroblock referencing information which were converted by the converting step.
